(19) United States
(12) Patent Application Publication
(10) Pub. No.: US 2008/0017513 A1
(43) Pub. Date: Jan. 24, 2008

(54) Process And System For Separation Of Organic Charged Compounds

(76) Inventors: Laurent Bazinet, L' Ancienne-Lorette (CA); Jean Amiot, L'Ancienne-Lorette (CA); Jean-Francois Poulin, Sainte-Foy (CA); David Labbe, Montreal (CA); Angeo Tremblay, Charlesbourg (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/591,238

(22) PCT Filed: Mar. 1, 2005
(86) PCT No.: PCT/CA05/00337

§ 371 Date: May 14, 2007

Related U.S. Application Data
(60) Provisional application No. 60/548,181, filed on Mar. 1, 2004.

(51) Int. Cl. B01D 61/42

(52) U.S. Cl. 204/530

(57) ABSTRACT

The present invention relates to a process and system for separating neutral and charged organic compounds from a solution or composition using anionic and cationic membranes in combination with at least one filtration membrane stacked in an electrodialysis cell. The process is preferably a batch recirculation process. The process and system allow to separate acid, neutral and basic compounds according to their charge and molecular weight through the electrolysis cell. In addition, the present invention allows a simultaneous separation of neutral and charged organic compounds.

### BACKGROUND OF THE INVENTION

1. Field of the Invention

The present invention relates to process and system for charge and molecular weight separation or organic charged and neutral compounds. Particularly, the compounds can be classified as food or pharmaceutical ingredients, preferably from natural sources, but also from synthetic sources. Separated fractions obtained after performing the process and system of the invention, comprises peptides and proteins separated regarding targeted charges, anionic, neutral or cationic, alone or in combination with targeted molecular weight depending of the needs.

2. Description of the Prior Art

The ability to produce food and pharmaceutical ingredients from natural sources becomes increasingly attractive to the respective industries. For example, milk proteins fractionated by enzymatic treatment are known of having several physiological activities. Milk proteins, especially caseins, are an important source of bioactive peptides produced in vitro. β-lactoglobulin (β-lg), one of the major whey components was shown to contain different bioactive sequences according to the enzyme used: trypsine release β-lg 102-105 fraction (so-called β-lactorphin) that has an opioid-like activity, β-Lg 142-148 fraction has an ACE-inhibitory activity, β-lg 71-75 fraction has a hypocholesterolemic activity, and β-lg 15-20 and 92-100 fractions with an anti-microbial activity. However, these bioactive peptides contained in protein hydrolysates have to be fractionated to obtain peptides fractions with higher functionality or higher nutritional value in a more purified form. However, few techniques allow efficient separation or isolation of peptides, mostly charged peptides, from different sources, such as natural composition, infusions or others.

For the isolation of active peptides from usually complex compositions containing various hydrolyzed protein fractions of similar size, membrane filtration has a too low selectivity whereas chromatography is too expensive.

It has been seen that electro-filtration, a process combining a pressure gradient and an electrical potential gradient as driving forces was used for separation of bio-active peptides from casein-αₛ₂ (Bargeman et al., 2000, Lait. 80:175-185) and β-lg hydrolysates. A membrane filtration module was used to produce pressure gradient. However, pressure gradient modules produce the accumulation of molecules on the nearby membrane surface and then modification of the membrane transport selectivity. The use of porous membranes in replacement of ion-exchange membrane used in an electrodialysis module was investigated. One derived cellulose membrane was used with a 100 kDa molecular cut-off, placed in an electrophoretic membrane contactor, to separate the poly(L-glutamic) acid (1000 Da), the α-lactalbumin (14 000 Da) and the bovine hemoglobin, in a single passage. Separation yield reached 86% for α-lactalbumin with a purity of 60% (Galier et Roux-de Balmann, 2004, Journal of Membrane Science, 241: 79-87).

Electrodialysisis (ED) is a membrane separation process in which ions species are induced to move by an electrical potential and are separated from water, macrosolutes and all uncharged solutes by means of ion-exchange membranes.

Ion-exchange membranes are traditionally highly distended gels containing polymers with a fixed ionic charge, allowing passage of anions or cations and very little else. To enlarge the use of ED purification to a wide range of molecules, ion-exchange membranes require optimization. It is however acknowledged that such optimisation involves majors tradeoffs between electrical resistance, selectivity and mechanical properties. This means that the membrane must be conductive to counterions and do not unduly restrict their passage through the membrane. For example, mechanical properties are improved with cross-link density, but so does the electrical resistance.

Since most of the ED membranes are made by chemical modification of polymers or by polymerization of functional monomers and cross linking agents, the pores formed by the interstices within the polymer have a random size and do not allow the purification of molecules based on their size. At the opposite, dialysis, ultrafiltration and nano-filtration membranes allows the purification of molecules based on size. They however appear useless in ED since their electrical resistance in an ED system would be inappropriately high. The purification of molecules based on their size and ED are therefore most of the time performed separately.

U.S. Pat. Nos. 4,043,896 and 4,123,342 report an ultrafiltration and electrodialysis method and apparatus. These patents particularly report a method and apparatus in which a solution to be treated is fed to one side of an ultrafiltration membrane cell, a concentration solution is delivered between a cation-selective and an ion-non-selective membrane, and an electric field is applied across the ED cell assembly. The ultrafiltration step separates proteins while the application of an electric field increases demineralisation of the solution. The inventions described in these patents however have important drawbacks since they combine two distinct processes within the same apparatus. Indeed, the ultrafiltration process is generated by a pressure of 10 to 100 psi, exerted on the UF membrane, which therefore requires the membrane to be thicker in order to be resistant enough. Consequently, the overall resistance of the system is significantly increased. For example, such a system requires 6 mm-thick ultrafiltration membranes that generate an overall resistance of 3.4 ohm-cm² in 1.0N NaCl. Therefore, this system is very demanding on energy consumption and is less interesting for industrial purposes.

As a consequence of the compromises between electrical resistance, selectivity and mechanical properties, ED has its greatest use in removing ions from solutions, such as salt from brackish water and has not been used to purify molecules based on their size, even though it could theoretically have been done with numerous charged molecules.

There is also a relatively wide range of literature regarding ECTEOLA cellulose for purification of nucleic acid. ECTEOLA cellulose has been produced by coupling triethanolamine, N(CH₂—CH₂—OH)₃ to cellulose using epoxide. It has been considered that the resulting groups are CH₂—CHOHCH₂—N⁺ (CH₂—CH₂—OH)₃, i.e. ECTEOLA cellulose is a strong ion exchanger. However, it has been shown that commercial variants of ECTEOLA cellulose have relatively high buffer capacity at pH 7-10, which indicates presence of weak ion exchanging groups, which in turn means that hydroxyl groups in triethanol amine has been used for binding to cellulose. Ion exchangers based on triethanol amine, which through reaction with epoxide, have been coupled to cellulose are not comprised within the scope of the new matrices of the invention.

Considering the state of the art, it remains highly desirable to be provided with new process and system for separating peptides and proteins from a biological composition in relation of their charge, molecular weight or combinations thereof.

### SUMMARY OF THE INVENTION

One aim of the present invention is to provide a process for separation of charged proteins or peptides in a composition, said process comprising the steps of: a) passing at least once a composition comprising charged proteins or peptides mixed with a permeate through an electrodialysis cell, the electrodialysis cell consisting in order, in at least one cationic membrane, at least one ultrafiltration membrane, and at least one anionic membrane; and b) collecting separated fractions of permeate after passage with the composition through the filtration membrane, each separated fraction containing separately acid, neutral or basic peptides or proteins. The process is be preferably a batch recirculation process.

Another aim of the present invention is to provide a process and system in which the acid, neutral or basic peptides or proteins are separated simultaneously while performing the process.

The process may be comprised of an filtration membrane that is, for example but non limited to, a cellulose ester ultrafiltration membrane. The filtration membrane may also have a molecular weight cut off of between 0.1 to 100 kDa in addition to the fact that it can be charged or neutral membrane.

The term “filtration” as used herein is intended to mean a membrane that may have a well defined molecular weight cut-off, for example but non limited to, ultrafiltration membrane, or with a non well-defined pore size, for example but non limited to, perfluored homopolar ionic membrane, in addition to the fact that it can be charged or neutral membrane. Although, homopolar ion-exchange membrane has non well-defined pore, their cross-linking degree establishes the structural matrix level of ionic restriction and its porosity. The porosity of electrodialysis membranes may vary from 10-100 Å depending upon the application. The porosity determines the ion selectivity. Membranes made ‘loose’ have a porosity of ˜100 Å and allow a higher permeability for ions of the same sign, or charge, as the fixed charges (or co-ions) than do membranes made ‘tight’ having a porosity of ˜20 Å, which allow a negligible permeability towards co-ions. A typical membrane for ED use has a porosity of 10-20 Å.

The process of the present invention can be applied on composition having a high range of pH, which can be of between 2 to 11.5.

For example, but not limited to, the process of the present invention can be applied also for separation of peptides or proteins from a composition comprising as well animal as vegetable proteins or peptides.

The electrode solution that is used in the present process and system is generally a salted or ionisable solution, such as, but not limited to, a NaCl or Na₂SO₄ solution at 20 g/L.

According to another aspect of the present invention, the process can be performed on charged molecules or compounds, such as proteins or peptides that are physically, chemically or enzymatically hydrolyzed before performing step a) as described herein. The proteins and peptides can be originating directly from natural sources, or can be as well synthetic or recombinant peptides or proteins.

In one aspect of the process, the composition can flow through the electrodialysis cell at a rate of between 0.1 to 500 L/min., but preferably between 0.1 to 10 L/min., and the permeated at a rate of 0.1 to 150 L/min.

It will be admitted by those skilled in the art that any anionic, neutral or cationic organic molecule or compound of natural origin or being synthetically obtained, can be separated, isolated or concentrated while applying the process and/or system of the present invention.

The process is performed preferably by continuous recirculation of the composition through the electrodialysis cell, but under different adaptations of the system of the present invention, can also be performed on a continuing operation. The recirculation can be done as well by a permeate or dilution solution containing the composition in which charged compounds are, as by ionic solutions passing in sections or chambers contiguous to the section or chamber through which passes the charged compounds or molecules to be isolated or concentrated.

The process can alternatively make use of a permeate that is a pure H₂O or a salted solution thereof. The permeate may comprises salts, for example but not limited to, at a concentration of between 0.1 to 10 g/L.

The process is useful in separating acid proteins or peptides having pH of below 5.0, neutral proteins or peptides at pH between 5.0 to 8.0, and basic proteins or peptides at pH over 8.0.

In accordance with another aspect of the invention there is provided a process and system making use of having at least two ultrafiltration membranes allowing targeted molecular weight separation of peptides and proteins in combination with targeted charge separation.

The electrodialysis cell may comprises at least two ultrafiltration membranes, each ultrafiltration membrane can have a molecular weight cut-off different from the other or the others. In addition, the electrodialysis cell may comprises at least one cationic membrane, at least one ultrafiltration membrane and at least one anionic membrane, each membrane being separately compartmented. Each compartment may contain solution or permeate with pH different from other compartments.

### BRIEF DESCRIPTION OF DRAWINGS

FIGS. 1a and 1b illustrate according to embodiments of the present invention two configurations of an electrodialysis cell using one ultrafiltration membrane for the separation from an β-lg hydrolysate of a) cationic peptides or b) anionic peptides. AEM anion-exchange membrane, UFM: ultrafiltration membrane and CEM: cation-exchange membrane;

FIG. 2 illustrates a configuration according to another embodiment of the invention, of an electrodialysis cell using two ultrafiltration membranes for the simultaneous separation from an β-lg hydrolysate of cationic and anionic peptides. UF membrane. AEM: anion-exchange membrane, UFM: ultrafiltration membrane and CEM: cation-exchange membrane;

FIG. 3 illustrates the evolution of conductivity as a function of time in hydrolysate and KCl solutions during electrodialysis with one ultrafiltration membrane of β-lg hydrolysates adjusted at pH 5.0 and pH 9.0;

FIG. 4 illustrates the evolution of global system resistance as a function of time during electrodialysis with one ultrafiltration membrane of β-lg hydrolysates adjusted at pH 5.0 and pH 9.0;

FIG. 5 illustrates the evolution of peptide concentration in KCl solution as a function of time during electrodialysis with one ultrafiltration membrane of β-lg hydrolysates adjusted at pH 5.0 and pH 9.0;

FIG. 6 illustrates the evolution of conductivity as a function of time in hydrolysate and KCl solutions during electrodialysis with two ultrafiltration membranes of β-lg hydrolysates adjusted at pH 5.0, pH 7.0 and pH 9.0;

FIG. 7 illustrates the evolution of pH as a function of time in hydrolysate and KCl solutions during electrodialysis with two ultrafiltration membranes of β-lg hydrolysates adjusted at pH 5.0, pH 7.0 and pH 9.0;

FIG. 8 illustrates the evolution of the global system resistance as a function of time during electrodialysis with two ultrafiltration membranes of β-lg hydrolysates adjusted at pH 5.0, pH 7.0 and pH 9.0;

FIG. 9 illustrates the evolution of the peptide concentration in the KCl 1 solution as a function of time during electrodialysis with two ultrafiltration membranes of β-lg hydrolysates adjusted at pH 5.0, pH 7.0 and pH 9.0;

FIG. 10 illustrates the evolution of the peptide concentration in the KCl 2 solution as a function of time during electrodialysis with two ultrafiltration membranes of β-lg hydrolysates adjusted at pH 5.0, pH 7.0 and pH 9.0;

FIG. 11 shows chromatograms of initial β-lg hydrolysate feed solution adjusted at pH 9.0 and of feed, KCl 1 and KCl 2 solutions after a 240 min-treatment of electrodialysis with two ultrafiltration membranes;

FIG. 12 shows chromatograms of initial β-lg hydrolysate feed solution adjusted at pH 5.0 and of feed, KCl 1 and KCl 2 solutions after a 240 min-treatment of electrodialysis with two ultrafiltration membranes;

FIG. 13 shows chromatograms of initial β-lg hydrolysate feed solution adjusted at pH 7.0 and of feed, KCl 1 and KCl 2 solutions after a 240 min-treatment of electrodialysis with two ultrafiltration membranes;

FIGS. 14a and 14b show alternative configurations of electrodialysis membranes arrangements comprising anionic and UF membranes, respectively;

FIG. 15 is a curve of the pH of a green tea infusion as a function of electrodialysis time with different ion-exchange membranes;

FIG. 16 is a curve of the conductivity of a green tea infusion as a function of electrodialysis time with different ion-exchange membranes;

FIG. 17 is a curve of the electrical resistance of a green tea infusion as a function of electrodialysis time with different ion-exchange membranes;

FIG. 18 is a curve of the epigallocatechin (EGC) concentration (μg/ml) of a green tea infusion as a function of electrodialysis time with different ion-exchange membranes;

FIG. 19 is a curve of the caffeine (Caf) concentration (μg/ml) of a green tea infusion as a function of electrodialysis time with different ion-exchange membranes;

FIG. 20 is a curve the epicatechin (EC) concentration (μg/ml) of a green tea infusion as a function of electrodialysis time with different ion-exchange membranes;

FIG. 21 is a curve of the epigallocatechin gallate (EGCG) concentration (μg/ml) of a green tea infusion as a function of electrodialysis time with different ion-exchange membranes;

FIG. 22 is a curve of the gallocatechin gallate (GCG) concentration (μg/ml) evolution of a green tea infusion as a function of electrodialysis time with different ion-exchange membranes; and

FIG. 23 is a curve of the epicatechin gallate (ECG) concentration (μg/ml) of a green tea infusion as a function of electrodialysis time with different ion-exchange membranes.

### DESCRIPTION OF THE PREFERRED EMBODIMENT

The present invention now will be described more fully hereinafter with reference to the accompanying drawings, in which preferred embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

All patents, patent applications, articles and publications mentioned herein, both supra and infra, are hereby incorporated herein by reference.

In accordance with the present invention, there is provided a process for simultaneous isolation, separation or concentration of compounds according to their charge, in combination or not with the separation in relation with their molecular weight.

In another embodiment of the present invention, the process and system can be used when needed to allow simply the cleaning of neutral organic compounds from charged molecules.

Also, according to another aspect of the present invention, there is provided a system to perform the invention process described herein. The system is characterized in comprising at least one anionic membrane, at least one ultrafiltration membrane, or device, and at least one cationic membrane. The porosity of the ultrafiltration membrane can be adapted for separating peptides or proteins having molecular weight of between about 0.1 to 100 kDa. It is comprised herein that the number of each membrane, anionic, ultrafiltration, and cationic can be highly variable depending of the needs. There can be between 1 to 500 of each membrane in a single system. This will allow the separation of compounds in a composition through also a high number of combinations regarding the charge and molecular weight of each compound.

In one embodiment, the present invention provides a method for purifying a neutral or charged compound from a solution by electrodialysis. The method of the present invention is carried out by submitting the solution to an electrical potential coupled with the pH action in an electrodialysis cell, where the electrical potential induces charged compounds to move through an ion exchange or filtration membrane arrangement. This membrane arrangement allows the enrichment of a second solution with a compound of interest.

The membrane arrangement may comprise homogenous-type ion exchange membranes or an heterogenous-type ion exchange membranes. The membrane may be a strongly acidic cation permeable membrane, a strongly basic anion permeable membrane (A), a strongly acidic cation permeable membrane (C) or a strongly basic anion selective membrane. These may include, but are not limited to, the following membranes: CMX, AMX, CL-25T, CM-1, CM-2, ACH-45T, AM-1, AM-2, AM-3, ACM, AMH, CMS, ACS, AFN, AFX, ACL E-5P, CLE-E, CGG-10F, CIMS, CMH, C66-10F, ACS-3, CMB, AHA, CMV, CMO, AMV, ASV, ASO, AST, APS, DMV, CMT, CMS, AMT, ASS, AAV, AMP, AMD, DSV, AAV, HSV, CMD, HSF, A-101, A-171, A-201, A-211, K-101, K-171, K-172, MC 3470, MA 3475, MC 3142, MA 3148, 61AZ L386, 61AZ L389, 61CZ L386, 103QZ L386, 103PZ L386, 204SX ZL386, 204U386C-60, C-103C, C-313, A-60, A-104BR-4010, R-4035, R-1010, R-1035, CR 61 AZL 065, CR 61 AZL 183, CR 61 CZL 183, AR 103 PZL 065, AR 103 PZL 183, AR 103 QZL 219, AR 111 A, CRP, ARP, N117, N901, AQ CA-01, AQ CA-O₂, AQ AA-06, PC Acid 35, PC Acid 70, PC 100D, PC 200D, PC 400D, BP-1, AQ-BA-06, AQ-BA-04 or NEOSEPTA® AXE 01. For example, but not limited to, a peptide or any organic compound can have anionic charges, due to the presence of hydroxyl or ester groups, and therefore can be isolated from a composition according to an embodiment of the present invention, through membrane arrangement that comprises at least one anion-exchange membrane, such as PC400 D™, AFN or AMX anion-exchange membrane.

It is also an embodiment of the present invention to provide a membrane arrangement that comprise at least one membrane having pores of a uniform size such as dialysis, ultrafiltration or nanofiltration membranes. This may allows electro-induced filtration of compoundss having molecular weight of between 0.01 to 100 000 Daltons, but preferably 0.1 to 100 Daltons. Such membranes are preferably used since they can be selected according to the relative size of the molecule to be purified, contrarily to the majority of anionic or cationic membranes that comprise random pore sizes or no real pore size.

It is an embodiment of the present invention to provide a membrane having pores of a uniform size that is uncharged. Also provided is a conditioned uncharged membrane. A conditioned membrane may be obtained by immersing a non conditioned membrane in a salt solution, such as a sodium chloride solution or a potassium chloride solution, for at least five (5) minutes, and more preferably for at least one hour prior to its use in performing the process. The use of conditioned ultrafiltration membrane, for example, provides an advantage over non conditioned membranes since it contributes to significantly reduce the resistance of the membrane and thus, of the entire electrodialysis system.

The membrane arrangement of the present invention may comprise any arrangement of anionic (A), cationic (C), ionic (I) and ultrafiltration (UF) membranes. For example, an electrodialysis cell may comprises at least one membrane arrangement such as C/UF/I, C/UF/UF/C, C/UF/UF/UF/C, where the size of the pores of each UF is adapted so as to enhance the separation of the different molecules.

Examples of solution from which compounds or interest can be purified may consist of plant infusion, such as tea infusion, or processed compound composition, such as peptide or protein from milk, or composition derived from dairy products. It will be admitted by those skilled in the art that the process of the present invention can be applied on any source of peptides and proteins from which a peptide or peptides, neutral or charged, to result in isolation, separation, or concentration of the peptides. For example again, fruits such as grape, apple, apricot, blackberry, or cherry or products derived from scutellaria and bamboo, could be used as raw material to obtain isolated or concentrated desired charged compound. The second solution in which charged compounds are found after being subjected to the process is preferably a salt solution, more preferably potassium chloride solution and even more preferably a 2 g/L KCl solution, though sodium solutions or solution of other compounds useful in preparing ionic solutions can be used.

Among compounds that can be isolated or concentrated through performing the process of the present invention, can be found any organic charged compound or molecule, such as, but not limited to, peptides, proteins, glucides, sugars, polyphenols, nucleic acids molecules, enzymes, hormones, blood products, glycoproteins, lipoproteins, vitamins, acids, fatty acids, growth factors, carbohydrate, anti-oxydants, porphyrins, nucleotides, or derivatives thereof, and any biologically originating compounds or compounds biologically actives, such as pharmaceuticals, nutraceuticals or cosmeceutical compounds. The charged molecule that can be isolated or concentrated by the process or system as described herein can be of animal as well as of vegetal origin. It is comprised here the synthetic charged molecules as defined herein can also be isolated or concentrated by the process and/or system of the present invention. For example, a group of molecules that can be processed with the process and system of the invention are flavonoids, which are plant secondary metabolites that are widely distributed in the plant kingdom and that can be subdivided into six classes: flavones, flavanones, isoflavones, flavonols, flavanols, and anthocyanins based on the structure and conformation of the heterocyclic oxygen ring (C ring) of the basic molecule (Wang et al., 2000, Trends in Food Science & Technology. 11:152-160). The main classes of flavonoids found in green tea are flavanols and more precisely catechins. Catechins are antioxidants having a potentially beneficial effect on the body (Merken and Beecher, 2000, J Agric Food Chem. 48: 577-599). The method of the present invention may be used also to purify any charged flavonoids, from such as epigallocatechin gallate (EGC), epicatechin (EC), epigallocatechin gallate (EGCG), gallocatechin gallate (GCG) or epicatechin gallate (ECG). A skilled artisan will understand that the method may also find uses in the purification of molecules according to a certain range of positive and negative charges

Another embodiment of the present invention is to provide a system to perform simultaneous isolation, separation or concentration of peptides or proteins according to their charge, in combination or not with the separation in relation with their molecular weight.

The system of the present invention in one embodiment comprised of a filtration membrane, which can be selected for nano-filtration, micro-filtration, or for filtration according to a selected molecular weight cut-off, in combination with at least one anionic or cationic membrane. The system is preferably in a close configuration with chambers through which circulates ionic solutions with pre-determined pH or ionic charge. The chambers are generally, but not limited to, positioned in parallel one to the others, and separated by filtration membranes. The types and characteristics of the filtration membranes is as illustrated herein above and through the following examples.

When passing in a chamber, a solution containing the peptides, or a composition of peptides to be separated or concentrated, the pH of the feed solution induces a charge dependant selective separation of the peptides, while at the same time, the filtration membrane performs a separation of the peptides by molecular weight exclusion, or passage permission. It is understood here that the pH of the feed solution, or primary composition, or permeate, is adjusted in order to maintain, or protect, the charge of the compounds or molecules to be isolated or concentrated. The pH of each solution in the process and system of the present invention is therefore adjusted prior isolating or concentrating the compounds or molecules in such a way that the charge of the compounds or molecules in maintain, preserved or protect to facilitate or maintain the efficiency of the process and system.

It is admitted herein that the pH of the solution contiguous to the chamber in which passes the primary feed solution or composition attracts separated from the feed solution by filtration membrane may also induced a charge dependant selective separation. The primary peptide composition or feed solution, can be recirulated several times through the system and until the isolation, separation or concentration yield is obtained.

For people skilled in the art, it will be admitted that the pH of a solution or buffer influences the ionization of a charged molecule such as protein or polyphenols, and consequently its electrical mobility under an electrical current. Hence, on catechins for example, but not omited to, the presence of OH groups on catechins implies a susceptibility to the effect of pH and thus, an ionization of the molecule. One measurement of the global charge of the polyphenols is the ζ-potential. More precisely, at pH 3, the EGCG ζ-potential was of 3.70 and decrease to −2.23 at pH 4. ζ-potential decrease further in a linear fashion while pH increase to reach −10.23 at pH 8. For caffeine, a very similar behaviour was observed. A ζ-potential of 4.10 at pH 3, of −1.03 at pH 4 and a decrease in a linear fashion with an increase of pH to a value of −9.93 at pH 8. For EGCG and caffeine, the ζ-potential is equal to zero between pH 3 and 4. And thus, the negative charges on EGCG and caffeine are lost when pH goes under the ζ-potential zero point. Similar results are reported in the literature for milk proteins.

It is noteworthy, according to a particular embodiment of the present invention, that no pressure is applied to the membrane. Only the charged molecules migrated under the effect of the electric field and the neutral molecules remain in the primary solution or composition and do not reach or pass the filtration membrane. The fact that only the charged molecules are in contact with the UF membrane decreases the possibility of fouling and the polarization concentration layer at the interface of the UF membrane is probably less consistent than in pressure-driven processes. Consequently the selectivity of the filtration membrane is relatively not changed by the formation of a layer at the interface.

According to another embodiment of the present invention, the electric field applied to the electrodialysis cell can be, but not limited to, a direct current, a pulsed current or a reverse polarity current to improve depending on needs, the separation, concentration or migration of charged organic molecules and to limit the formation of an eventual scale. For example, the polarity of the electrodes can be reversed regularly, as may be 5 minutes every 30 to 60 minutes, or some seconds at every periods of some minutes, such as at each 1 to 60 minutes. This swaps the low and high concentration compartments, together with the polarisation layers on the sides of the membranes, to displace and remove deposits.

The present invention will be more readily understood by referring to the following examples which are given to illustrate the invention rather than to limit its scope.

### Example I

### Separation of Milk Derived Peptides

Materials

Chemicals

NaCl and KCl were obtained from Laboratoire MAT (Quebec, QC, Canada). HCl and NaOH 1.0 M solutions were obtained from Fisher Scientific (Montreal, Canada).

Raw Material

A bovine β-lactoglobulin tryptic hydrolysate, prepared as previously described by Groleau et al (2002, Journal of Agricultural and Food Chemistry. 50:578-583). and characterized by Lapointe et al (2003, J. Membrane Sci. 212:55-67), was obtained from Advitech Solutions (Quebec, QC, Canada).

Electrodialysis Cells and Configurations

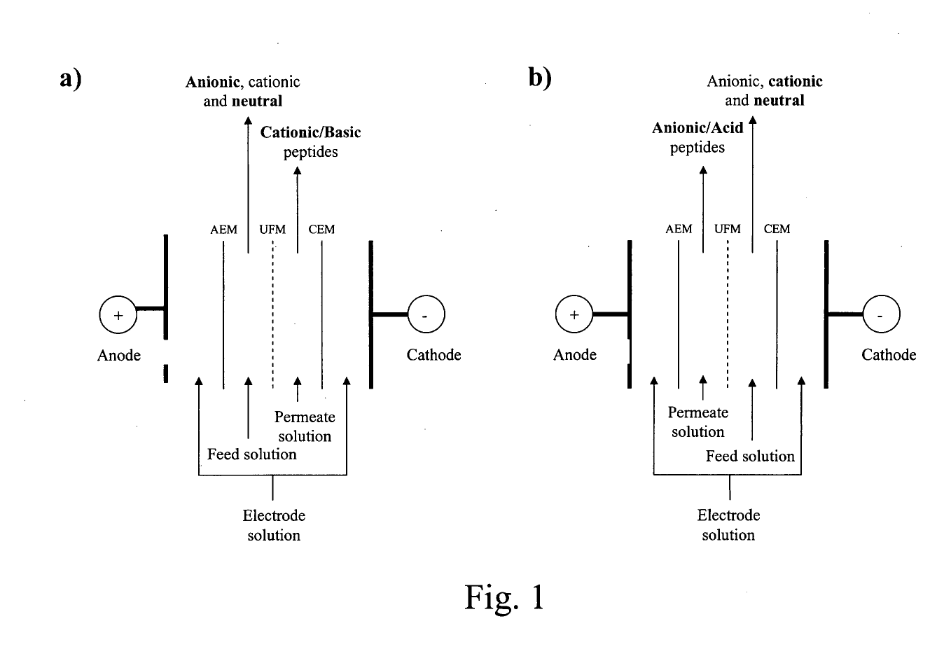

The electrodialysis cell used for the first experiment was a MicroFlow type cell (effective area of 10 cm²) (ElectroCell AB, Taby, Sweden) with one Neosepta CMX-S cationic membrane (Tokuyama Soda Ltd., Tokyo, Japan), one Neosepta AMX-SB anionic membrane (Tokuyama Soda Ltd.) and one cellulose ester ultrafiltration membrane with a molecular weight cut-off (MWCO) of 20 kDa (SpectraPor™). Two different cell configurations (FIGS. 1a and 1b) were used for an hydrolysate solution adjusted to pH 5.0 or 9.0. These configurations defined three closed loops. Each closed loop was connected to a separate external reservoir to allow continual recirculation of the solutions. The solutions were circulated using three centrifugal pumps and the flow rates were controlled using flowmeters. The anode was a dimensionally-stable electrode (DSA) and the cathode was a 316 stainless steel electrode. The anode/cathode voltage difference was supplied by a variable 0-30 V power source (model HPD 30-10SX, Xantrex™, Burnaby, BC, Canada). The system was not equipped to maintain the temperature of the solutions constant.

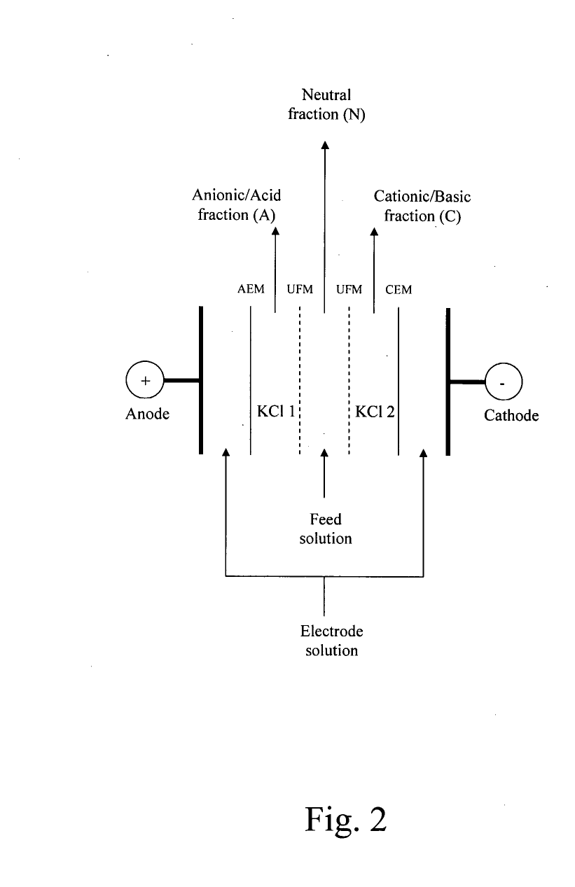

The electrodialysis cell used for the second part of the experiments was a MP type cell (effective area of 100 cm²) (ElectroCell AB™) with one Neosepta CMX-S™ cationic membrane (Tokuyama Soda Ltd.), one Neosepta AMX-SB™ anionic membrane (Tokuyama Soda Ltd.) and two cellulose ester ultrafiltration membranes with MWCO of 20 kDa (SpectraPor™). The configuration of the cell, presented in FIG. 2, defined four closed loops. Each closed loop is connected to a separate external reservoir to allow continual recirculation of the solutions. The solutions were circulated using four centrifugal pumps and the flow rates were controlled using flow-meters. The anode, a dimensionally-stable electrode (DSA), and the cathode, a 316 stainless steel electrode, were supplied with the MP cell. The anode/cathode voltage difference was supplied by a variable 0-100 V power source. The system was also not equipped to maintain the temperature of the solutions constant.

Methods

Protocol

The first experiment was conducted to demonstrate the feasibility of EDFM (electrodialysis with filtration membrane) for the separation of peptides from a whey hydrolysate. Electroseparation was performed in batch process using a constant voltage difference of 5.5 V. The duration of the treatment was 2h30. The electrode, permeate and feed compartments contained a 20 g/L NaCl aqueous solution (250 ml), a 2 g/L KCl aqueous solution (250 ml) and a 1% (w/v) β-lactoglobulin tryptic hydrolysate aqueous solution (250 ml) respectively (FIG. 1). The permeate and feed solution flow rates were 200 ml/min while the flow rate of the electrode solution was 300 ml/min. Two pH values for the hydrolysate solution were tested; pH 5.0 in configuration FIG. 1a and pH 9.0 in configuration FIG. 1b.

Three replicates of each experiment were performed. Samples (1.5 ml) of the hydrolysate and KCl solutions were taken before applying voltage and every 30 minutes during the treatment. The protein content of the permeate samples was determined with a BCA protein assay kit. Conductivity and pH of the permeate and feed solutions were recorded throughout the process as well as the current intensity. After each treatment, the UF membrane electrical conductivity and thickness were measured to evaluate its potential fouling.

The goal of the second part of the experiment was to use a special cell configuration in order to separate simultaneously positively-charged and negatively-charged peptides from the feed solution by electrodialysis with filtration membrane (EDFM) (FIG. 2). Electroseparation was performed in batch process using a constant voltage difference of 6.0 V. The duration of the treatment was 4 h. The electrode, permeate and feed compartments contained respectively a 20 g/L NaCl aqueous solution (5 L), a 2 g/L KCl aqueous solution (2.5 L) and a 1% (w/v) β-lactoglobulin tryptic hydrolysate aqueous solution (2.5 L). The permeate and feed solutions flow rates were 2 L/min while the flow rate of the electrode solution was 5 L/min. Three pH, for the hydrolysate solution, were tested, 5.0, 7.0 and 9.0, and three replicates of each experiment were performed. Samples (10 ml) of the hydrolysate and KCl solutions were taken before applying voltage and every hour during the treatment. The molecular profile of hydrolysate, permeate and feed solutions samples was determined by RP-HPLC. The protein content of the permeate samples was also determined with a BCA protein assay kit. Conductivity and pH of the permeate and feed solutions were recorded throughout the process as well as the current intensity. After each treatment, the UF membrane electrical conductivity and thickness were measured to evaluate the fouling.

Analysis

pH

A pH-meter model SP20 (Thermo Orion, West Chester, Pa., USA) was used with a VWR Symphony epoxy gel combination pH electrode (Montreal, Canada).

Conductivity

A YSI conductivity meter, Model 3100, was used with a YSI immersion probe model 3252, cell constant K=1 cm⁻¹ (Yellow Springs Instrument Co., Yellowsprings, Ohio, USA).

System Resistance

The system resistance was calculated, using Ohm's Law, from the voltage and the current intensity read directly from the indicators on the power supply.

Total Protein Determination

The protein concentration was determined using BCA protein assay reagents (Pierce, Rockford, Ill., USA). Assays were conducted on microplates by mixing 25 μL of the sample with 200 μL of the working reagent and incubating at 37° C. for 30 minutes. The microplate was then cooled to room temperature for 15 minutes and the absorbance was read at 562 nm on a microplate reader. Concentration was determined with a standard curve in a range of 25 to 2000 μg/ml.

Peptides Profiles

The peptide composition of the permeate and hydrolysate solutions was determined by RP-HPLC according to the method of Groleau et al (2003, J. Agricul. Food Chemist., 51: 4370-4375). The system used was an Agilent 1100 Series (Agilent Technologies, Palo Alto, Calif., USA) consisting of an autosampler (G1329A), two pumps (bin G1323A) and a diode array detector (DAD G1315A). Peptides were analyzed with a Luna 5 μm C₁₈ column (2 i.d.×250 mm, Phenomenex, Torrance, Calif., USA). Solvent A, TFA 0.11% (v/v) in water, and solvent B, acetonitrile/water/TFA (90%/10%/0.1% v/v), were used for elution at 0.2 ml/min. A linear gradient of solvent B, from 1% to 50% in 60 minutes, was used. The detection wavelength was 214 nm.

Membrane Electrical Conductivity

The membrane electrical conductivity was measured according to Bazinet et Araya-Farias (2005, Journal of colloid and interface science, 281:188-196) using a specially designed clip from the Laboratoire des Matériaux Échangeurs d'Ions (Créteil, France).

Membrane Thickness

Thickness of the membrane was measured using a Mitutoyo Corp. digimatic indicator (Model ID-110 ME, Japan) and digimatic mini-processor (Model DP-1HS, Japan), specially devised for plastic film thickness measurement. The resolution was of 1 μm and the range of 10 mm.

Results and Conclusion

Feasibility of EDFM

Conductivity

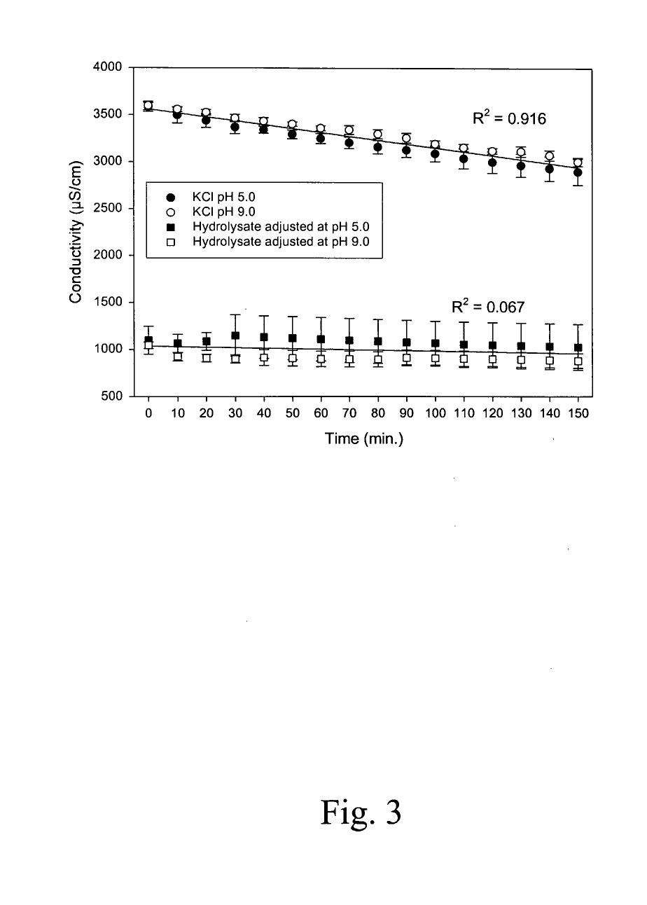

Conductivity of feed and permeate solutions was monitored over the duration of the process. The conductivity of the KCl solution decreased linearly, beginning at an average value of 3589±11 μS/cm and ending at an average value of 2950±75 μS/cm (FIG. 3). This decrease corresponds to a 18% demineralization. The pH of the hydrolysate solution did not affect the demineralization rate of the permeate solution. The same behaviour was observed for the hydrolysate solution, but the percentage of demineralization was different depending on the pH of the solution. Demineralization was approximately two times higher for a pH value of 9.0 than for a pH value of 5.0 (15.8% and 6.6% respectively). These results are in accordance with the cell configuration, which allows the ions to migrate from the KCl and feed solutions to the electrode solution.

The pH of the hydrolysate solution, whether it was adjusted to a value of 5.0 or 9.0 at the beginning of the treatment, slightly changed over the 150 minutes. In fact, the pH value increased from 5.03 to 5.34 for the acid solution and decreased from 8.91 to 8.65 for the alkaline solution. These results were expected as the separations are performed under the limiting-current density (6.5V, 36.6 mA) to avoid water-splitting, which would have ended up in more important pH changes requiring pH control on line. On the other hand, the pH of the permeate solution presented more changes, increasing from 5.61 to 7.67 when the hydrolysate solution was adjusted to pH 9.0 and from 5.41 to 6.23 when the hydrolysate solution was adjusted at pH 5.0. In both cases, the pH changes observed in the two compartments are in accordance with the theory. When the feed solution is basic, OH-ions and/or negatively-charged peptides would migrate towards the anode, passing from the feed to the permeate across the UF membrane. Hence, the pH of the feed solution decreased and the permeate's pH increased. Ion the opposite, when the pH of the hydrolysate was acid, the H⁺ and/or positively-charged peptides migrated towards the cathode through the UF membrane, increasing the pH of the feed and decreasing the pH of the permeate.

System Resistance

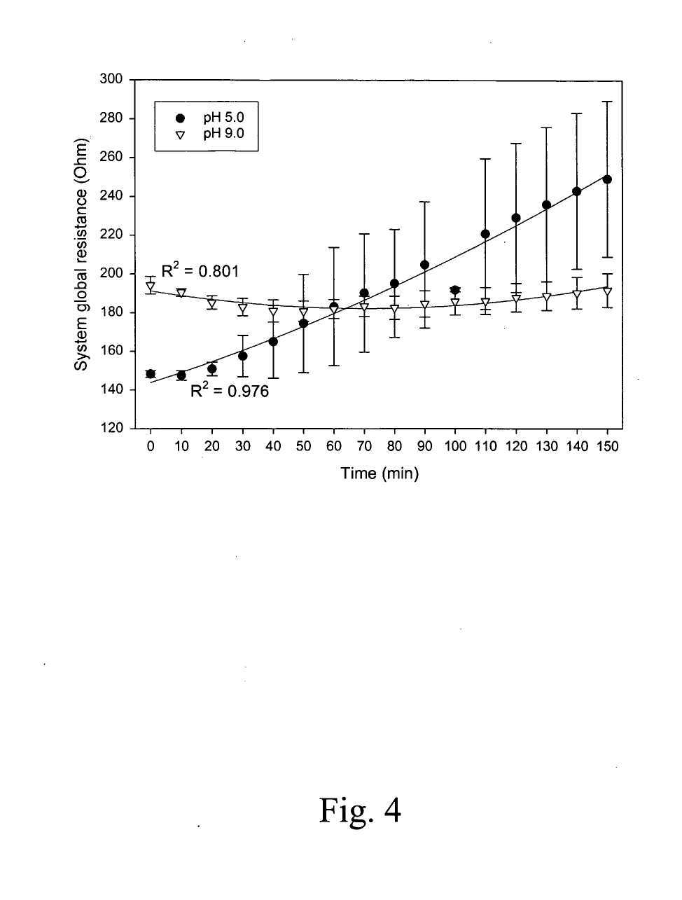

The overall system resistance evolved differently over the treatment for an acid or alkaline hydrolysate solution (FIG. 4). When the solution was alkaline, the global resistance stayed almost the same all over the process, between values of 190 to 195 ohms. On the other hand, when the initial solution was acid, the resistance increased linearly from 148 to 250 ohms, which corresponds to a 69% augmentation. This difference could be attributed to a fouling of the UF membrane when the hydrolysate solution was at pH 5.0. In fact, bringing the solution to an acidic pH induces hydrophobic interactions between the peptides which afterwards form a precipitate. These peptide aggregates would be responsible for membrane fouling and hence for the increase of the electrical resistance.

Peptides Migration

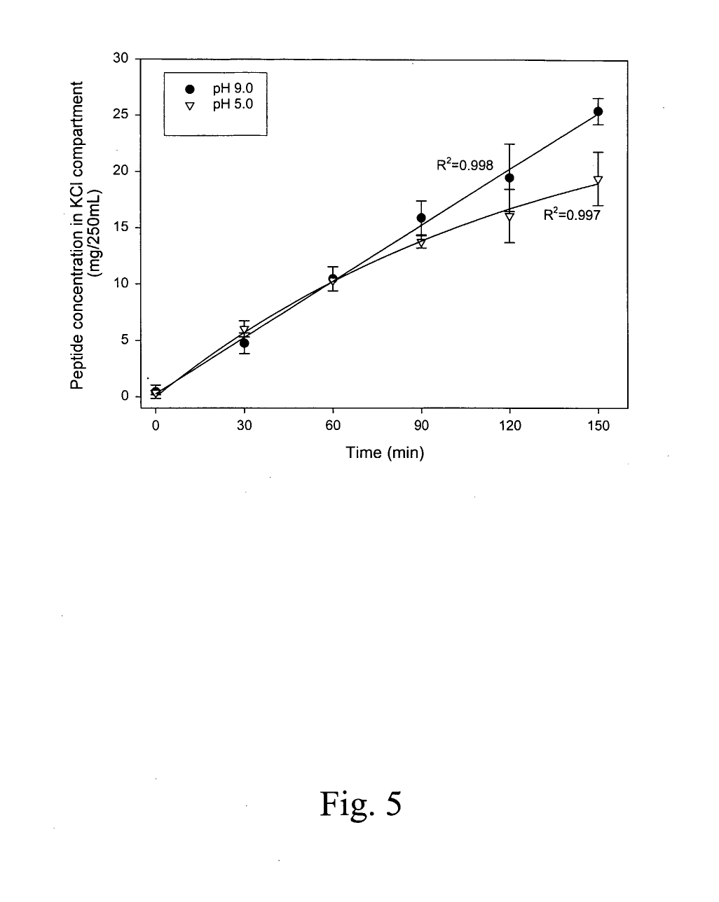

Migration was determined by quantifying total protein in the permeate solution. For an hydrolysate solution with a pH value of 9.0, peptide concentration in the permeate increased linearly from an initial value of 0 mg/250 ml to a final one of 25.5 mg/250 ml (FIG. 5). The transport rate was estimated to 10.2 g/m².h. For an hydrolysate solution with a pH value of 5.0, the concentration in the permeate increased in a linear way until 90 minutes, and then reached a plateau (FIG. 5). The final concentration was 19.4 mg/250 ml and the transport rate was estimated to 7.8 g/m².h. The inferior transport rate for the pH 5.0 condition could again be attributed to a possible membrane fouling caused by peptide aggregates. These results are in accordance with those of Bargeman et al (2002), who worked on the fractionation of an αₛ₂-casein hydrolysate with an EMF module using UF membranes. They reported average transport rates of 2.5 and 4 g/m².h, for peptide f(183-207), with UF membrane of 25 and 100 kDa MWCO respectively. However in their studies, the applied voltage difference was 10 times higher than the present one, for average transport rates 2 to 4 times lower.

Membrane Fouling Evaluation

The membrane initial electrical conductivity was 1.097 mS/cm and decreased to 0.888 mS/cm after the first treatment. Afterwards, it varied between 0.874 and 0.974 mS/cm with no apparent tendency. This means that between the six electro-separation runs, the fouling was weak and could be removed only by rinsing the membrane with distilled water. Membrane thickness was also measured after each treatment but no significant changes were observed (0.298±0.002 mm).

Simultaneous Separation of Acid and Basic Peptides by EDFM

Conductivity

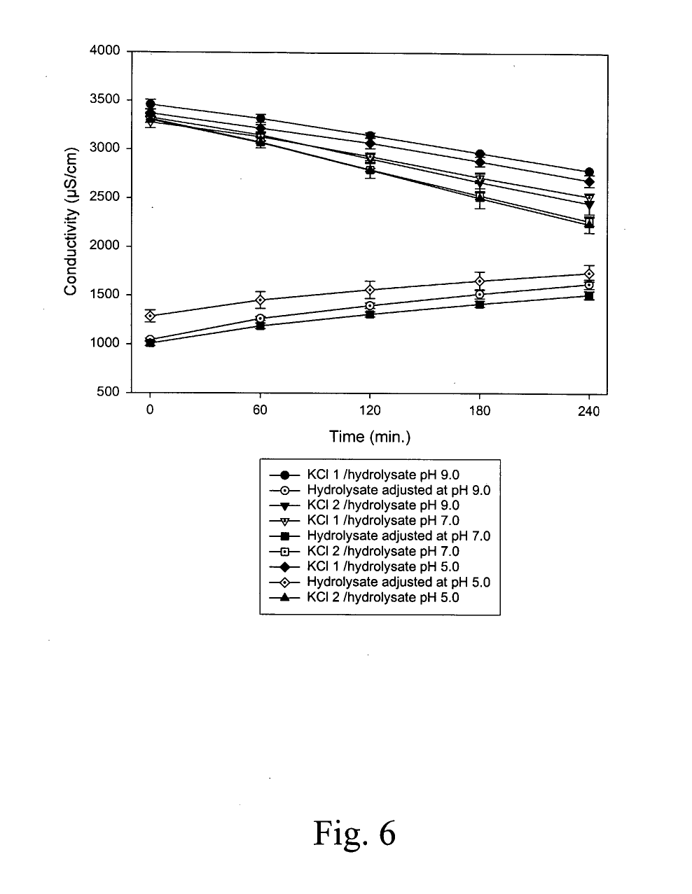

When using a two UF and three compartments ED configuration (FIG. 2), conductivity of the first permeate solution (KCl 1) evolved similarly, whether the hydrolysate solution was adjusted to pH 5.0, 7.0, or 9.0 (FIG. 6). It decreased in a linear fashion over the 240 minutes treatment, starting at an average value of 3368±12 μS and ending at an average value of 2668±133 μS (21% demineralization). The same trend was observed for the demineralization of the second permeate solution (KCl 2). The conductivity decreased linearly from an average initial value of 3314±12 μS to an average final value of 2324±115 μS (30% demineralization). As for the first part of the experiments, demineralization of the permeate solutions is in accordance with the cell configuration. On the other hand, the conductivity of the feed solution behaved in the opposite way of the permeate solutions. In fact, conductivity increased from 1112±151 μS to 1627±114 μS over the process (46% mineralization). This could be due to the migration of K⁺ and Cl⁻ ions, respectively from the KCl 1 and KCl 2 solutions to the feed solution. These ions would migrate towards their respective electrode (K⁺ towards the cathode and Cl⁻ towards the anode) to the feed solution and increasing its conductivity.

pH

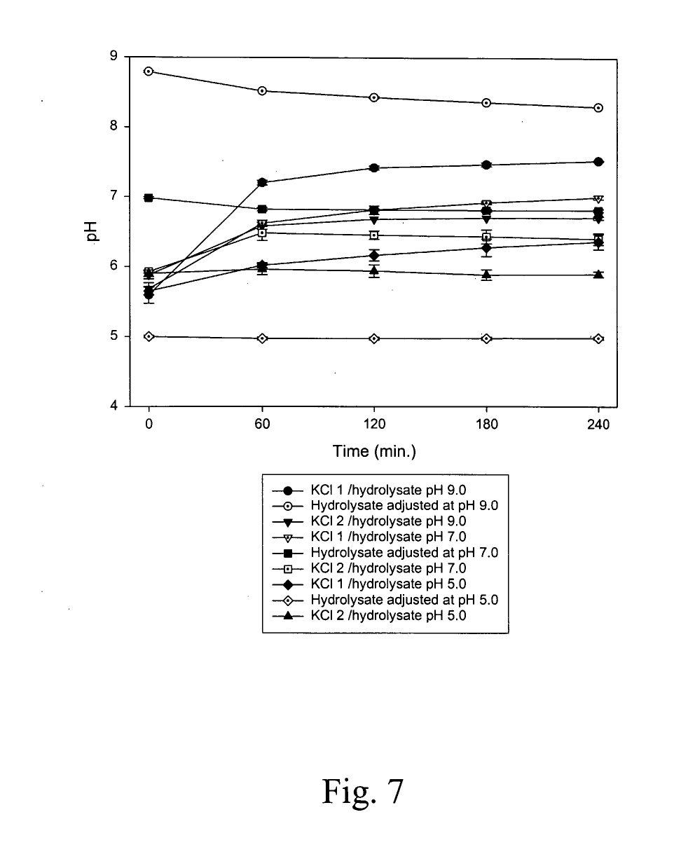

As in the first part of the experiments, the pH of the hydrolysate solution only slightly changed over the treatment. For the acid condition the pH value decreased from 5.00 to 4.98 while it decreased from 6.98 to 6.81 for the neutral condition and from 8.79 to 8.30 for the basic condition (FIG. 7). The pH of KCl 1 solution increased in time for the three conditions. It started at an average value of 5.64±0.04 and ended at values of 6.36, 7.00 and 7.53 for an hydrolysate solution adjusted to pH 5.0, 7.0 and 9.0 respectively. These results followed the theory; OH⁻ ions and/or anionic peptides migrate from the feed solution to the KCl 1 solution, towards the anode, and induce an increase of the pH of the solution. The more the hydrolysate solution is basic, the more the pH increase in the KCl 1 solution is important as more OH⁻ ions and/or basic peptides can migrate. The pH of KCl 2 solution did not change for the acid condition (5.90) and increased from 5.93 to 6.40 for the neutral condition and from 5.88 to 6.71 for the basic condition. In this case, the results do not apply to the previous logic as H⁺ ions and/or cationic peptides migrated in this compartment and lowered the pH.

System Resistance

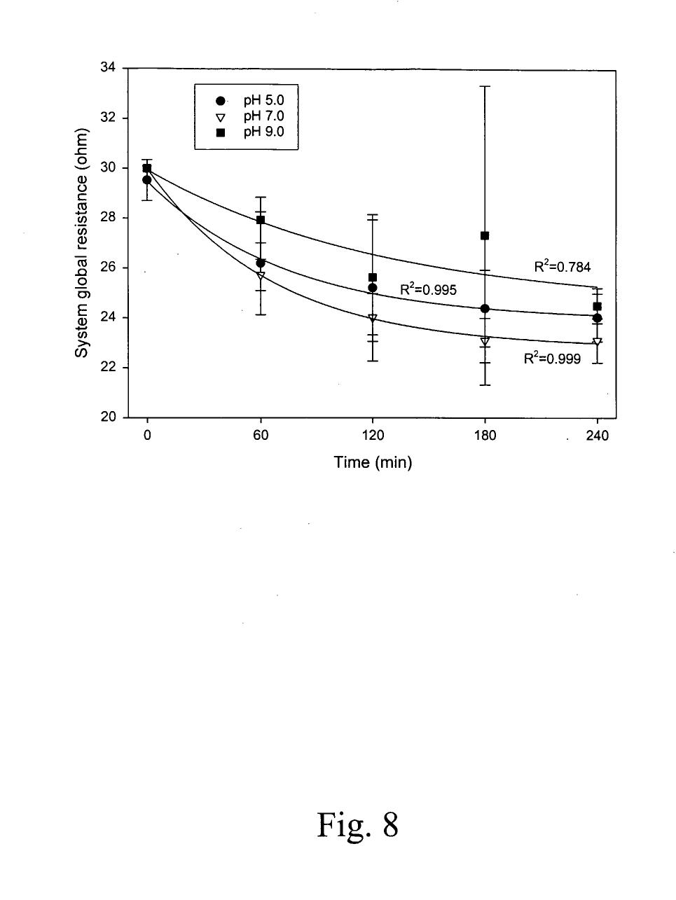

The overall system resistance evolved in the same way for an acid, neutral or basic hydrolysate solution (FIG. 8). It decreased from an average value of 30 ohms to an average value of 24 ohms in 240 minutes. This diminution of electrical resistance could be explained by the mineralization of the feed solution which facilitates current transport. Based on these results, the two UF/three compartment ED configuration would be a better configuration than the one UF/two compartment since it allows a decrease in the system resistance and consequently would consume less energy.

Total Protein Determination

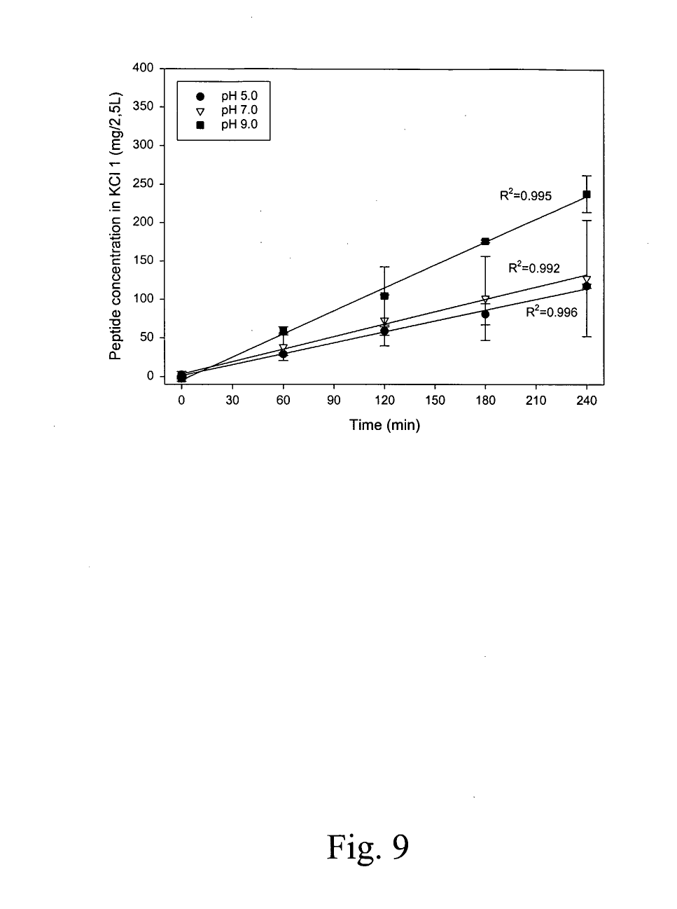

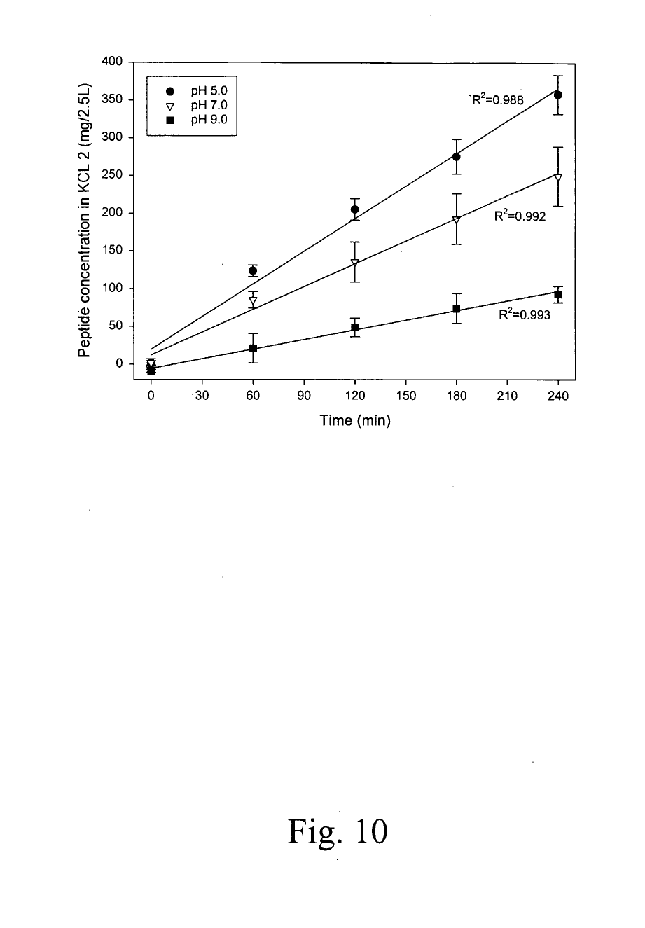

Peptide concentration in the KCl 1 and KCl 2 solutions was dependant on the initial pH value of the feed solution. In fact, as presented in FIG. 9, a higher peptide concentration in the KCl 1 permeate was found for a hydrolysate solution adjusted to pH 9.0 (238 mg/2.5 L), followed by pH 7.0 (128 mg/2.5 L) and 5.0 (118 mg/2.5 L). As mentioned earlier, the more the feed solution was alkaline, the more anionic peptides with negative net charge were present. So it was expected that a greater amount of molecules migrated towards the anode. For the KCl 2 permeate, the opposite tendency was observed as the total amount of migrated peptides was associated to a hydrolysate solution pH value of 5.0 (358 mg/2.5 L), followed by pH 7.0 (250 mg/2.5 L) and 9.0 (93 mg/2.5 L) (FIG. 10). Then again, this is in accordance with theory as there are more positively charged peptides when the solution is acid, that can migrate towards the cathode. In the three pH conditions and for the two permeate compartments, the peptide concentration increased linearly in time. By adding up the amount of peptides migrated in each permeate, transport rate for each condition can be estimated. The transport rates were evaluated to 11.9 g/m².h, 9.5 g/m².h and 8.3 g/m².h for a hydrolysate solution initially adjusted to pH 5.0, 7.0 and 9.0 respectively. Furthermore, migration rates observed in KCl 2, would explain the differences in pH observed for this compartment. In fact the migration of a large amount of peptides at pH 5.0 will induce a high buffer capacity to the KCL 2 solution and the fixation of the free H⁺. Less H⁺ ions were able to migrate across the cationic membrane and this would explain the stability of the pH in these conditions. On the opposite way, the relative low migration rate measured at pH 9.0 will induce a less important buffer capacity and then allow the migration of H⁺ across the cation-exchange membrane, which consequently induced a pH increase.

Molecular Profiles

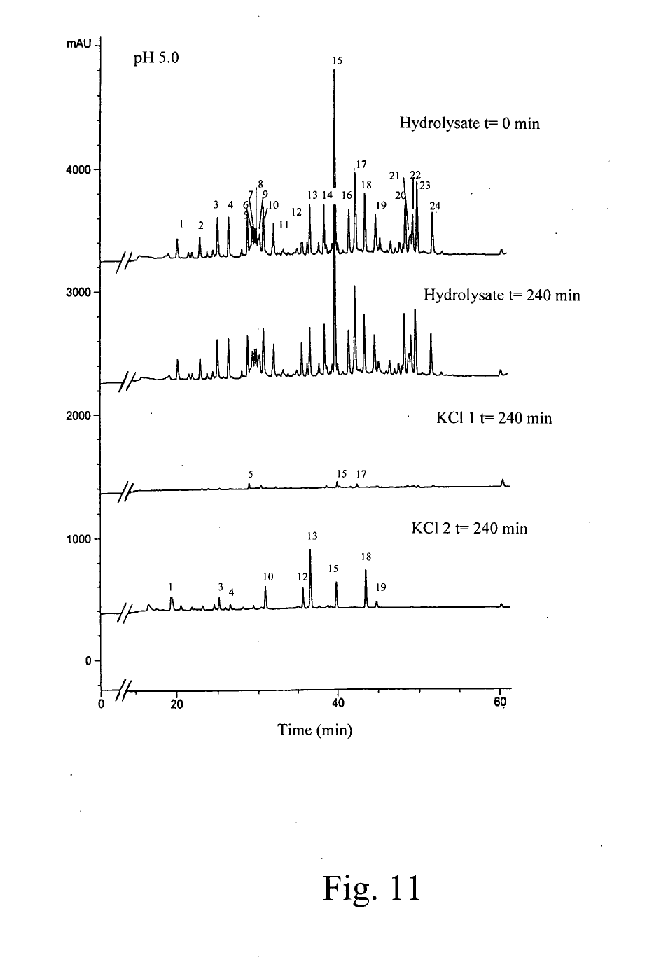

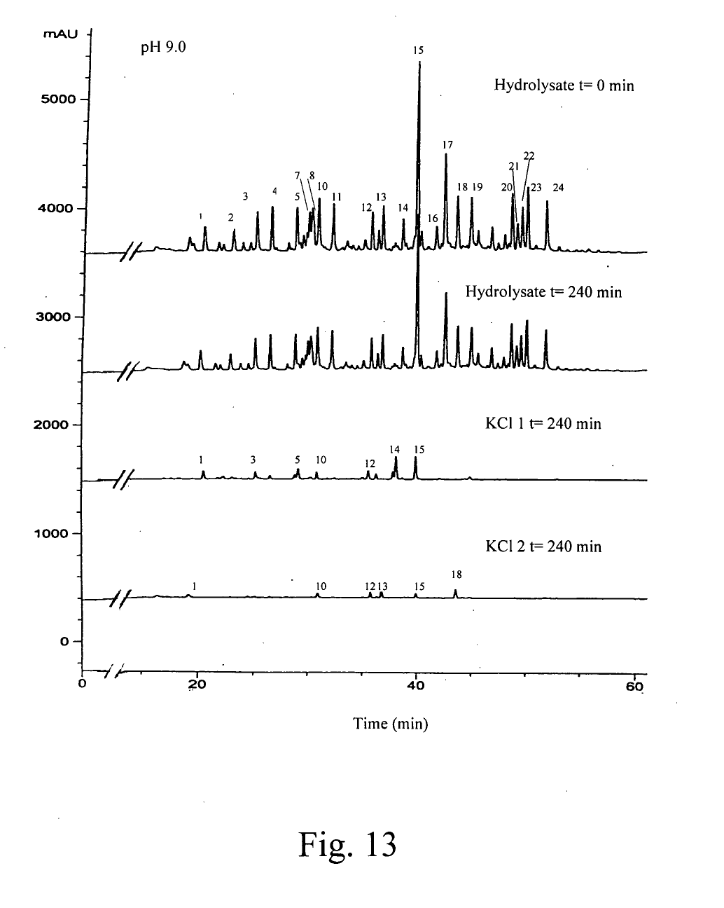

The results of the molecular profiles of the KCl 1 and KCl 2 solutions presented in tables 1 and 2 confirmed the general trends observed previously for the total peptide migration but give an important information about the peptide migrated during the EDUF process and their kinetic of migration. It appeared from these results that 13 peptides in the hydrolysate had migrated for all the conditions. However, there were not the same peptides which migrated in the same conditions (FIGS. 11-13).

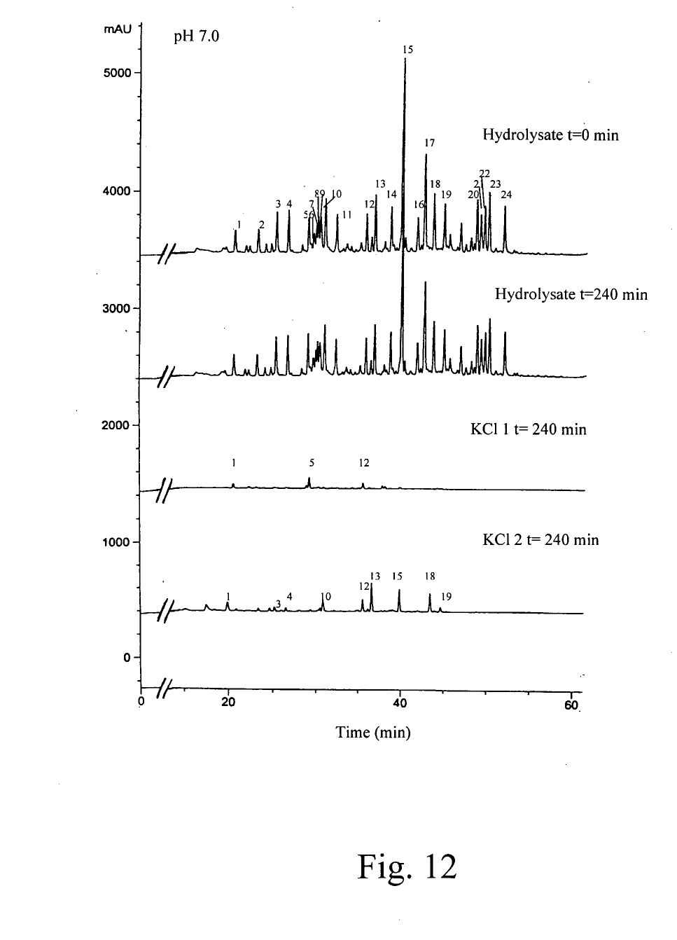

In the KCl 1 compartment, three peptides were not present whatever the pH conditions; peptides number 4, 13, and 18. Amongst the thirteen peptides, four main peptides had final migrated transmission above 2.5%: peak number 1, 5, 12 and 14. For each of these four main peptides their transmission rate increased with the pH. Their optimal migration rate was at pH 9.0, with transmission rate at the end of the treatment of 2.61, 3.53, 2.82 and 7.03% respectively (Table 1, FIG. 11). In this compartment, 3 other peptides were also identified as minor peptides, which concentration increased also with pH: peaks number 3, 10 and 15. These minor peptides reached final transmission close to 1.0% at pH 9.0. In this compartment, at pH 5.0, only three peptides had migrated after 240 minutes of treatment; peaks 5, 15 and 17 (Table 1, FIG. 12). Peaks 15 and 17 were closed to 0.1% while peak 5 shown a transmission of 0.93%.

In the KCl 2 compartment, peptides number 2, 5 and 14 were not transmitted whatever the pH conditions of the hydrolysate solution. On the opposite, four main peptides has final transmission rate overpassing 3.9%: peaks number 10, 12, 13 and 18. The transmission rate of these peptides increased with a decrease in pH. Their optimal migration rate was at pH 5.0 (Table 2, FIG. 12), with transmission rates at the end of the treatment of 3.90, 4.83, 10.75 and 4.99% respectively. In this compartment, one other peptide was also identified as minor peptide, which concentration decreased also with pH; peak number 15 reached a final transmission rate of 1.47% at pH 5.0 after 240 minutes of treatment. At pH 9.0, only five peptides were present in KCl 2 at the end of the treatment; peaks 10, 12, 13, 15 and 18 with transmission rates ranging from 0.15 to 1.53% (Table 2, FIG. 11).

TABLE 1
Evolution of the migration rates in the KCl 1 solution of the thirteen peptides of interest selected and associated
with peak number.

| | | IDENTIFICATION PEAK NUMBER | | | | | | | | | | | | | |
|---|---|---|---|---|---|---|---|---|---|---|---|---|---|---|---|
| | | 1 | | 2 | | 3 | | 4 | | 5 | | 10 | | 12 | |
| pH | Time | Avg | ±SD | Avg | ±SD | Avg | ±SD | Avg | ±SD | Avg | ±SD | Avg | ±SD | Avg | ±SD |
| 5.0 | 0 | 0.00 | 0.00 | 0.00 | 0.00 | 0.00 | 0.00 | 0.00 | 0.00 | 0.00 | 0.00 | 0.00 | 0.00 | 0.00 | 0.00 |
| | 60 | 0.00 | 0.00 | 0.00 | 0.00 | 0.00 | 0.00 | 0.00 | 0.00 | 0.00 | 0.00 | 0.00 | 0.00 | 0.00 | 0.00 |
| | 120 | 0.00 | 0.00 | 0.00 | 0.00 | 0.00 | 0.00 | 0.00 | 0.00 | 0.30 | 0.28 | 0.00 | 0.00 | 0.00 | 0.00 |
| | 180 | 0.00 | 0.00 | 0.00 | 0.00 | 0.00 | 0.00 | 0.00 | 0.00 | 0.45 | 0.40 | 0.00 | 0.00 | 0.00 | 0.00 |
| | 240 | 0.00 | 0.00 | 0.00 | 0.00 | 0.00 | 0.00 | 0.00 | 0.00 | 0.93 | 0.21 | 0.00 | 0.00 | 0.00 | 0.00 |
| 7.0 | 0 | 0.00 | 0.00 | 0.00 | 0.00 | 0.00 | 0.00 | 0.00 | 0.00 | 0.00 | 0.00 | 0.00 | 0.00 | 0.00 | 0.00 |
| | 60 | 0.15 | 0.27 | 0.00 | 0.00 | 0.00 | 0.00 | 0.00 | 0.00 | 0.00 | 0.00 | 0.00 | 0.00 | 0.15 | 0.26 |
| | 120 | 1.07 | 0.18 | 0.40 | 0.70 | 0.16 | 0.29 | 0.00 | 0.00 | 0.62 | 0.17 | 0.13 | 0.23 | 0.59 | 0.51 |
| | 180 | 1.08 | 1.01 | 0.68 | 1.19 | 0.25 | 0.44 | 0.00 | 0.00 | 1.17 | 0.53 | 0.16 | 0.27 | 0.74 | 0.65 |
| | 240 | 2.09 | 0.47 | 0.87 | 1.51 | 0.32 | 0.56 | 0.00 | 0.00 | 1.23 | 1.14 | 0.18 | 0.32 | 0.87 | 0.75 |
| 9.0 | 0 | 0.00 | 0.00 | 0.00 | 0.00 | 0.00 | 0.00 | 0.00 | 0.00 | 0.00 | 0.00 | 0.00 | 0.00 | 0.00 | 0.00 |
| | 60 | 0.34 | 0.49 | 0.00 | 0.00 | 0.10 | 0.19 | 0.00 | 0.00 | 0.41 | 0.09 | 0.23 | 0.01 | 0.46 | 0.05 |
| | 120 | 1.25 | 0.10 | 0.00 | 0.00 | 0.43 | 0.37 | 0.00 | 0.00 | 1.02 | 0.17 | 0.39 | 0.05 | 0.92 | 0.02 |
| | 180 | 2.14 | 0.01 | 0.00 | 0.00 | 0.73 | 0.63 | 0.00 | 0.00 | 3.14 | 1.90 | 0.65 | 0.02 | 1.55 | 0.16 |
| | 240 | 2.61 | 0.02 | 0.00 | 0.00 | 0.91 | 0.80 | 0.00 | 0.00 | 3.53 | 1.35 | 0.78 | 0.03 | 2.82 | 1.12 |

| | | IDENTIFICATION PEAK NUMBER | | | | | | | | | | | |
|---|---|---|---|---|---|---|---|---|---|---|---|---|---|
| | | 13 | | 14 | | 15 | | 17 | | 18 | | 19 | |
| pH | Time | Avg | ±SD | Avg | ±SD | Avg | ±SD | Avg | ±SD | Avg | ±SD | Avg | ±SD |
| 5.0 | 0 | 0.00 | 0.00 | 0.00 | 0.00 | 0.00 | 0.00 | 0.00 | 0.00 | 0.00 | 0.00 | 0.00 | 0.00 |
| | 60 | 0.00 | 0.00 | 0.00 | 0.00 | 0.00 | 0.00 | 0.00 | 0.00 | 0.00 | 0.00 | 0.00 | 0.00 |
| | 120 | 0.00 | 0.00 | 0.00 | 0.00 | 0.00 | 0.00 | 0.00 | 0.00 | 0.00 | 0.00 | 0.00 | 0.00 |
| | 180 | 0.00 | 0.00 | 0.00 | 0.00 | 0.07 | 0.13 | 0.07 | 0.12 | 0.00 | 0.00 | 0.00 | 0.00 |
| | 240 | 0.00 | 0.00 | 0.00 | 0.00 | 0.08 | 0.15 | 0.10 | 0.17 | 0.00 | 0.00 | 0.00 | 0.00 |
| 7.0 | 0 | 0.00 | 0.00 | 0.00 | 0.00 | 0.00 | 0.00 | 0.00 | 0.00 | 0.00 | 0.00 | 0.00 | 0.00 |
| | 60 | 0.00 | 0.00 | 0.00 | 0.00 | 0.17 | 0.12 | 0.00 | 0.00 | 0.00 | 0.00 | 0.00 | 0.00 |
| | 120 | 0.00 | 0.00 | 0.00 | 0.00 | 0.27 | 0.31 | 0.00 | 0.00 | 0.00 | 0.00 | 0.11 | 0.20 |
| | 180 | 0.00 | 0.00 | 0.13 | 0.24 | 0.39 | 0.60 | 0.00 | 0.00 | 0.00 | 0.00 | 0.19 | 0.33 |
| | 240 | 0.00 | 0.00 | 0.19 | 0.34 | 0.43 | 0.74 | 0.00 | 0.00 | 0.00 | 0.00 | 0.30 | 0.52 |
| 9.0 | 0 | 0.00 | 0.00 | 0.00 | 0.00 | 0.00 | 0.00 | 0.00 | 0.00 | 0.00 | 0.00 | 0.00 | 0.00 |
| | 60 | 0.00 | 0.00 | 1.30 | 0.01 | 0.52 | 0.08 | 0.00 | 0.00 | 0.00 | 0.00 | 0.00 | 0.00 |
| | 120 | 0.00 | 0.00 | 3.15 | 0.14 | 0.62 | 0.09 | 0.00 | 0.00 | 0.00 | 0.00 | 0.00 | 0.00 |
| | 180 | 0.00 | 0.00 | 6.22 | 0.15 | 0.59 | 0.42 | 0.00 | 0.00 | 0.00 | 0.00 | 0.00 | 0.00 |
| | 240 | 0.00 | 0.00 | 7.03 | 0.28 | 0.68 | 0.46 | 0.00 | 0.00 | 0.00 | 0.00 | 0.00 | 0.00 |

TABLE 2
Evolution of the migration rates in the KCl 2 solution of the thirteen peptides of interest selected
and associated with peak number.

| | | IDENTIFICATION PEAK NUMBER | | | | | | | | | | | | | |
|---|---|---|---|---|---|---|---|---|---|---|---|---|---|---|---|
| | | 1 | | 2 | | 3 | | 4 | | 5 | | 10 | | 12 | |
| pH | Time | Avg | ±SD | Avg | ±SD | Avg | ±SD | Avg | ±SD | Avg | ±SD | Avg | ±SD | Avg | ±SD |
| 5.0 | 0 | 0.00 | 0.00 | 0.00 | 0.00 | 0.00 | 0.00 | 0.00 | 0.00 | 0.00 | 0.00 | 0.00 | 0.00 | 0.00 | 0.00 |
| | 60 | 0.00 | 0.00 | 0.00 | 0.00 | 0.63 | 0.06 | 0.00 | 0.00 | 0.00 | 0.00 | 1.21 | 0.19 | 1.11 | 0.07 |
| | 120 | 0.00 | 0.00 | 0.00 | 0.00 | 1.22 | 0.21 | 0.66 | 0.12 | 0.00 | 0.00 | 2.17 | 0.50 | 2.14 | 0.10 |
| | 180 | 0.00 | 0.00 | 0.00 | 0.00 | 2.07 | 0.11 | 1.05 | 0.02 | 0.00 | 0.00 | 3.17 | 0.19 | 3.62 | 0.13 |
| | 240 | 0.00 | 0.00 | 0.00 | 0.00 | 2.67 | 0.24 | 1.36 | 0.03 | 0.00 | 0.00 | 3.90 | 0.30 | 4.83 | 0.14 |
| 7.0 | 0 | 0.00 | 0.00 | 0.00 | 0.00 | 0.00 | 0.00 | 0.00 | 0.00 | 0.00 | 0.00 | 0.00 | 0.00 | 0.00 | 0.00 |
| | 60 | 0.00 | 0.00 | 0.00 | 0.00 | 0.08 | 0.14 | 0.00 | 0.00 | 0.00 | 0.00 | 0.74 | 0.08 | 0.89 | 0.22 |
| | 120 | 0.00 | 0.00 | 0.00 | 0.00 | 0.62 | 0.09 | 0.55 | 0.11 | 0.00 | 0.00 | 1.49 | 0.16 | 2.03 | 0.31 |
| | 180 | 0.00 | 0.00 | 0.00 | 0.00 | 0.93 | 0.16 | 0.78 | 0.15 | 0.00 | 0.00 | 2.18 | 0.24 | 2.90 | 0.48 |
| | 240 | 0.00 | 0.00 | 0.00 | 0.00 | 1.29 | 0.00 | 1.04 | 0.00 | 0.00 | 0.00 | 2.92 | 0.19 | 3.77 | 0.88 |
| 9.0 | 0 | 0.00 | 0.00 | 0.00 | 0.00 | 0.00 | 0.00 | 0.00 | 0.00 | 0.00 | 0.00 | 0.00 | 0.00 | 0.00 | 0.00 |
| | 60 | 0.00 | 0.00 | 0.00 | 0.00 | 0.00 | 0.00 | 0.00 | 0.00 | 0.00 | 0.00 | 0.00 | 0.00 | 0.33 | 0.03 |
| | 120 | 0.00 | 0.00 | 0.00 | 0.00 | 0.00 | 0.00 | 0.00 | 0.00 | 0.00 | 0.00 | 0.32 | 0.01 | 0.68 | 0.03 |
| | 180 | 0.00 | 0.00 | 0.00 | 0.00 | 0.00 | 0.00 | 0.00 | 0.00 | 0.00 | 0.00 | 0.44 | 0.02 | 0.98 | 0.01 |
| | 240 | 0.00 | 0.00 | 0.00 | 0.00 | 0.00 | 0.00 | 0.00 | 0.00 | 0.00 | 0.00 | 0.61 | 0.02 | 1.23 | 0.03 |

| | IDENTIFICATION PEAK NUMBER | | | | | | | | | | | |
|---|---|---|---|---|---|---|---|---|---|---|---|---|
| | 13 | | 14 | | 15 | | 17 | | 18 | | 19 | |
| pH | Avg | ±SD | Avg | ±SD | Avg | ±SD | Avg | ±SD | Avg | ±SD | Avg | ±SD |
| 5.0 | 0.00 | 0.00 | 0.00 | 0.00 | 0.00 | 0.00 | 0.00 | 0.00 | 0.00 | 0.00 | 0.00 | 0.00 |
| | 2.69 | 0.44 | 0.00 | 0.00 | 0.32 | 0.02 | 0.00 | 0.00 | 1.29 | 0.13 | 0.00 | 0.00 |
| | 5.17 | 0.79 | 0.00 | 0.00 | 0.56 | 0.04 | 0.00 | 0.00 | 2.43 | 0.33 | 0.57 | 0.06 |
| | 8.49 | 1.09 | 0.00 | 0.00 | 1.02 | 0.11 | 0.00 | 0.00 | 3.93 | 0.23 | 0.94 | 0.05 |
| | 10.75 | 1.88 | 0.00 | 0.00 | 1.47 | 0.05 | 0.00 | 0.00 | 4.99 | 0.47 | 1.17 | 0.07 |
| 7.0 | 0.00 | 0.00 | 0.00 | 0.00 | 0.00 | 0.00 | 0.00 | 0.00 | 0.00 | 0.00 | 0.00 | 0.00 |
| | 1.75 | 0.48 | 0.00 | 0.00 | 0.31 | 0.06 | 0.00 | 0.00 | 0.78 | 0.13 | 0.07 | 0.12 |
| | 3.57 | 1.02 | 0.00 | 0.00 | 0.64 | 0.12 | 0.00 | 0.00 | 1.58 | 0.27 | 0.50 | 0.11 |
| | 5.02 | 1.27 | 0.00 | 0.00 | 0.93 | 0.17 | 0.00 | 0.00 | 2.32 | 0.35 | 0.72 | 0.16 |
| | 6.58 | 2.24 | 0.00 | 0.00 | 1.25 | 0.00 | 0.00 | 0.00 | 3.04 | 0.00 | 0.97 | 0.00 |
| 9.0 | 0.00 | 0.00 | 0.00 | 0.00 | 0.00 | 0.00 | 0.00 | 0.00 | 0.00 | 0.00 | 0.00 | 0.00 |
| | 0.44 | 0.05 | 0.00 | 0.00 | 0.00 | 0.00 | 0.00 | 0.00 | 0.29 | 0.03 | 0.00 | 0.00 |
| | 0.88 | 0.09 | 0.00 | 0.00 | 0.07 | 0.01 | 0.00 | 0.00 | 0.64 | 0.05 | 0.00 | 0.00 |
| | 1.21 | 0.03 | 0.00 | 0.00 | 0.11 | 0.02 | 0.00 | 0.00 | 0.90 | 0.07 | 0.00 | 0.00 |
| | 1.53 | 0.01 | 0.00 | 0.00 | 0.15 | 0.03 | 0.00 | 0.00 | 1.17 | 0.05 | 0.00 | 0.00 |

According to the characterization, peptides corresponding to peaks 5, 15, 17 would be acid peptides (pI<5.0), peaks 12, 13 and 18 would be basic peptides (pI>8.0). The other peptides would be associated with neutral peptides (8.0>pI>5.0) migrating in both compartment according to their charges at low or high pH. These results were in accordance with previous results observed for total peptides migration and the highest total amount of migrated peptides measured in KCl 2 at pH 5.0. Selective fractionation of acid, neutral and basic peptides from a tryptic β-lactoglobulin hydrolysate has been done using a <<loose>> nano-filtration membrane in a filtration module. They observed that while acid peptides were totally retained by the membrane at pH 5.0 and 9.0, further separation for basic and neutral peptides was obtained at pH 9.0 but the highest separation factor between basic and neutral species at pH 9.0 only reached values between 2 and 3. Furthermore this separation was primarily the results of electrostatic repulsion of the peptides bearing the same electrostatic charge as the negatively charged membrane. An electric field was applied during pressure-driven filtration to enhance the selective separation of nano-filtration to a 0.25% (w/v) tryptic hydrolysate. The highest separation factor was achieved at 5V with a G-10 membrane of molecular weight cut-off of 2500 g.mol⁻¹ at pH 9.0 and at the lowest trans-membrane pressure (0.244 MPa) and feed velocity (0.047 m.s⁻¹) studied. The relative concentration of the target basic sequence β-lg 142-148, was raised from 3.5% in the initial β-lg tryptic hydrolysate up to 38% in the permeate at 5V and pH 9.0. In the present experiments, the concentration of this peptide, corresponding to peak n°13, increased from 4.3±0.4% to 25.7±0.6% in the KCl 2 compartment after 240 minutes. However, in our work the hydrolysate was a 1% (w/v) β-lactoglobulin tryptic hydrolysate. Furthermore, it was not possible for the present experiment to follow the migration of this peptide in time and to quantify the total amount of peptide at the end of the process since the electrofiltration module was in a recirculation mode; results representing the relative peak area of the peptide in one collected sample of the retentate and the permeate. Furthermore, in the present experiment, the fact that the kinetic migration of this peptide and of all the peptides varied with respect to show that by increasing the surface of the membrane or the time of processing the migration rates should be increased in the different conditions.

Membrane Fouling Evaluation

Membrane Conductivity and Thickness

The initial electrical conductivity of the UF membrane situated on the anode side initial electrical conductivity was 1.106 mS/cm. It decreased slowly between each run to reach a final value of 0.879 mS/cm. This diminution is weak so it is considered not to be a significant membrane fouling. The conductivity of the UF membrane on the cathode side started at 1.111 mS/cm and ended at a value if 1.006 mS/cm. All along its use, this membrane electrical conductivity stayed constant so it can be said that no fouling occurred. The thickness of the two membranes was also measured after each treatment but no significant changes were observed (0.283±0.003 mm for the one on the anode side and 0.283±0.002 mm for the one on the cathode side).

Since no pressure was applied to the membrane, only the charged molecules migrated under the effect of the electric field and the neutral molecules stay in the solution and did not reach the membrane. The fact that only the charged molecules are in contact with the UF membrane decrease the possibility of fouling and the polarization concentration layer at the interface of the UF membrane is probably less consistent than in pressure-driven processes. Consequently the selectivity of the membrane is not changed by the formation of a layer at the interface for a nano-filtration membrane. EDUF would have the advantages of preserving the selectivity of the ultrafiltration membrane all along the process and to minimize its fouling.

### CONCLUSION

ED-UF combination showed to be a very selective method of separation of compounds since amongst a total of approximately 40 peaks in the raw hydrolysate, only 13 peaks were recovered in the adjacent solutions. Amongst these 13 migrating peptides, 4 highly acid migrated only in the KCl 1 compartment, while peptides number 4, 13 and 18 migrated only in the KCl 2 and that whatever the pH conditions of the hydrolysate solution. Furthermore, peptides 17 and 19 had low migration rate in KCl 1 whatever the conditions and higher migration rate in KCl 2 solution when the pH decreased. The other peptides had similar low migration rate in both KCl solution but with pH selectivity; best migration in KCl 1 when hydrolysate pH increased and best migration rate in KCl 2 solution when pH decreased.

According to the first measurement to evaluate UF membrane fouling, it appears that the integrity of the UF membrane was kept and that ED-UF would minimize the fouling of UF membrane.

ED-UF would be an interesting way to separate bio-active peptides and other charged molecules of interest from complex feed stocks, in the food, pharmaceutical fine chemical and fermentation industries, since it did not need the complete change of the ED configuration and that ED module are commercially available.

### Example II

### Purification of Catechins from a Green Tea Infusion

Materials and Methods

The green tea was a non-biological Japanese green tea (lot 12423TKA) obtained from local retailer La Giroflée (Québec City, QC, Canada). The green tea was stored at room temperature in a dark and dry space. (−)-Epicatechin, (−)-epigallocatechin, (−)-epicatechin gallate, (−)-epigallocatechine gallate, (−)-gallocatechin gallate and caffeine standards were obtained from Sigma Company (Saint-Louis, Mo., U.S.A.).

Three (3) anionic and one (1) ultrafiltration membranes, all commercially available, were selected according to their physico-chemical characteristics (Table 3).

TABLE 3
Physico-chemical characteristics of the three anionic
membranes and the ultrafiltration membrane.

| | UF 1000 Da | AMX-SB | AFN | PC-400 D |
|---|---|---|---|---|
| Electrical resistance (□/cm²) | N/D | 2.0-3.5 | 0.2-1.0 | 10 |
| Thickness (mm) | | 0.14-0.18 | 0.15-0.18 | 0.09-0.11 |
| Burst strength (kg/cm²) | N/D | 4.5-5.5 | 2.0-4.0 | 4.0-5.0 |

| | | | |
|---|---|---|---|
| Material | Cellulose | Polymer of | Nature non |
| | ester | polydivinylbenzene | communicated |
| | | and polystyrene | Reinforced with |
| | | Minimal reinforcement | polyester |

Methods
Electrodialysis Configuration

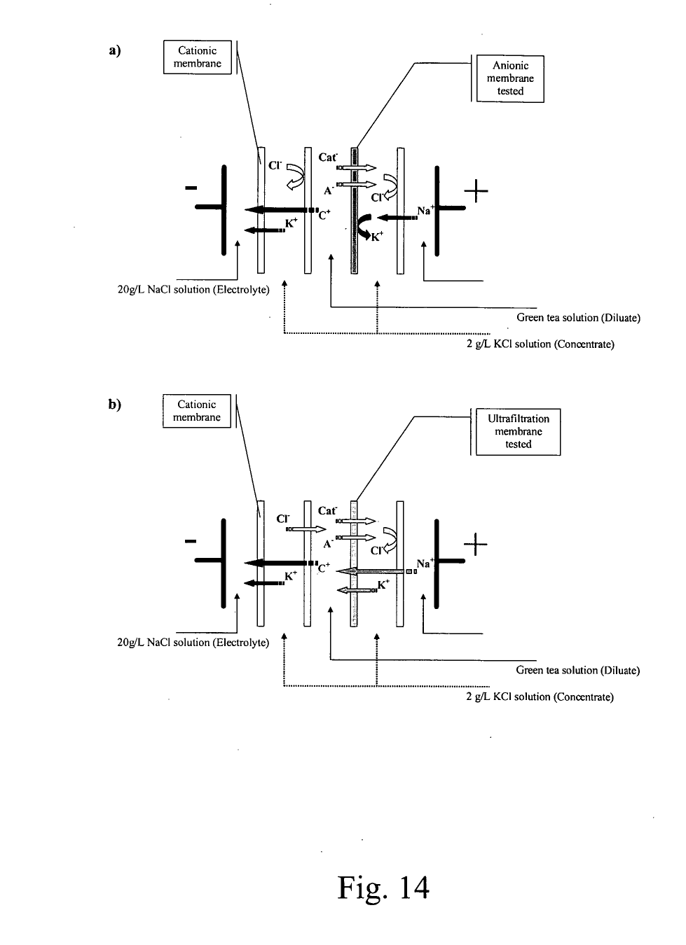

The module used was an MP type cell (100 cm2 of effective electrode surface) manufactured by ElectroCell (Taby, Sweden). The cell consisted of several compartments separated by cationic and tested membranes (FIG. 14). The compartments defined three closed loops containing the solution to be treated (green tea brewing), an aqueous potassium chloride solution (5 g/L KCl) and an electrolyte solution (20 g/L NaCl). Each closed loop was connected to a separate external reservoir to allow continuous recirculation of the solutions. The electrolytes were circulated using three centrifugal pumps, and the flow rates were controlled using flowmeters. The anode, a dimensionally-stable electrode (DSA), and the cathode, a 316 stainless-steel electrode, were supplied with the MP cell. The anode/cathode voltage difference was supplied by a variable 0-100 V power source.

Protocol

The capacity of the different membranes to enable the migration of catechin. was tested under the same conditions. Briefly, 20 g of green tea were brewed in 1000 ml of double-distilled water to solubilize catechins since it provides the 1:50 tea/water ratio suggested in the prior art. Tea leaves were brewed at 70° C. for 40 minutes in a thermo-regulated water-bath, quickly cooled down and stored at 4° C., until electrodialysis experiments.

Electrodialysis experiments were performed in a batch process with a constant current density of 1 A, 6 liters of electrolyte and a 2.5 liter of green tea infusion, for 1 hour. The initial pH of the green tea infusions ranged from 5.6 to 5.8. Samples of green tea infusions were taken before applying electrical current to the apparatus, and every ten minutes during the electrodialysis process. Anode/cathode voltage difference, conductivity and temperature were recorded throughout the process. Concentrations of catechins and caffeine were determined by HPLC on samples stored at 4° C.

The pH was measured with a pH-meter model SP20 (epoxy gel combination pH electrode, VWR Symphony), from Thermo Orion (West Chester, Pa., U.S.A.).

Conductivity

Conductivity was monitored at 4° C. using a YSI conductivimeter (model 3100-115 V, Yellow Springs, Ohio) and an immersion probe (model 3417, k=1/cm, YSI).

HPLC Method

The different samples of green tea infusion submitted to the electrodialysis process were filtered through a 0.20 μm filter (Aerodisc LC13 PVDF, Gelman Laboratory, Ann Arbor, Mich.) and diluted with HPLC grade water to be analyzed. Standard curves were calculated from a mix of flavanols and caffeine compounds at different concentrations: Correlations obtained ranged from 0.99808 to 0.99954. The RP-HPLC method was based on the National Institute of Standards and Technology method modified as follow:

Column: YMC-Pack ODS-AM, S-5 μm, 12 nm, Cat. number: AM-303, AM12S05-2546WT, Dimensions and serial number: 250×4.6 mm I.D., No. 042568112(W), Gel lot: 5531, Guard-column: YMC ODS-AM S-5 120 Å 4.0×20 mm DC Guard Cartridge, Particule number: AM12S050204WDA, Serial number: 502312331.

Pump: Beckman, System Gold programmable solvent module 126

Detector: Beckman, System Gold programmable detector module 116

Auto-injector: LKB Bromma 2157 autosampler

Software: Gold v8.10

Phase A: Water+0.05% TFA (purity >99%, Laboratoire MAT, Quebec, Cananda)

Phase B: Acetonitrile (HPLC grade, EMD Chemicals inc., NJ)+0.05% TFA (purity >99%, Laboratoire MAT, Québec, Canada)

The detection of analytes was performed by UV detection at 210 nm. The column temperature was maintained at 40° C. during analyses. Details on gradient used are listed in table 4. The mobile phases were filtered through a 0.2 μm nylon filter (Mendel Scientific Compagny, Guelph, ON, Canada).

TABLE 4
Gradient used for HPLC analysis

| Time (min) | % B |
|---|---|
| 0 | 12.0 |
| 22 | 20.0 |
| 32 | 100.0 |
| 42 | 12.0 |

Statistical Analysis

The experimental design is a complete randomized design with three repetitions. Data were subjected to an analysis of variance (ANOVA) using SAS software (Enterprise SAS Guide, Cary, N.C., U.S.A.). Multiple comparisons tests (LSD) (lowest significant test) were performed to determine the significance of differences between membranes tested.

Results and Discussion

pH

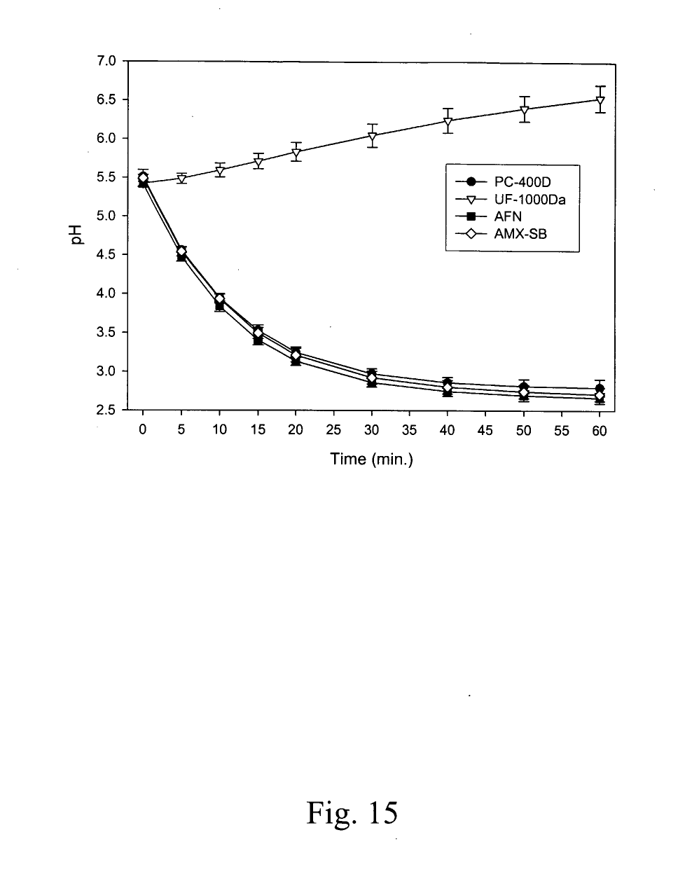

According to the variance analysis results, there was a significant effect of membrane type (P<0.001), duration (P<0.001) and dual interaction between membrane type and duration (P<0.001) on the pH throughout ED process (FIG. 15). The LSD tests showed that the differences observed with the different membrane types are significant (P<0.001). The pH varied similarly with the three anionic membranes, decreasing rapidly from an average value of 5.47 at the beginning to 2.92 after 30 minutes of treatment, to remain constant at an average value of 2.80 until the end of the ED process. Contrarily, the pH increased in a linear fashion from 5.42 at the beginning to pH 6.54 after 60 minutes of electrodialysis process with the UF-1000 Da membrane.

Conductivity

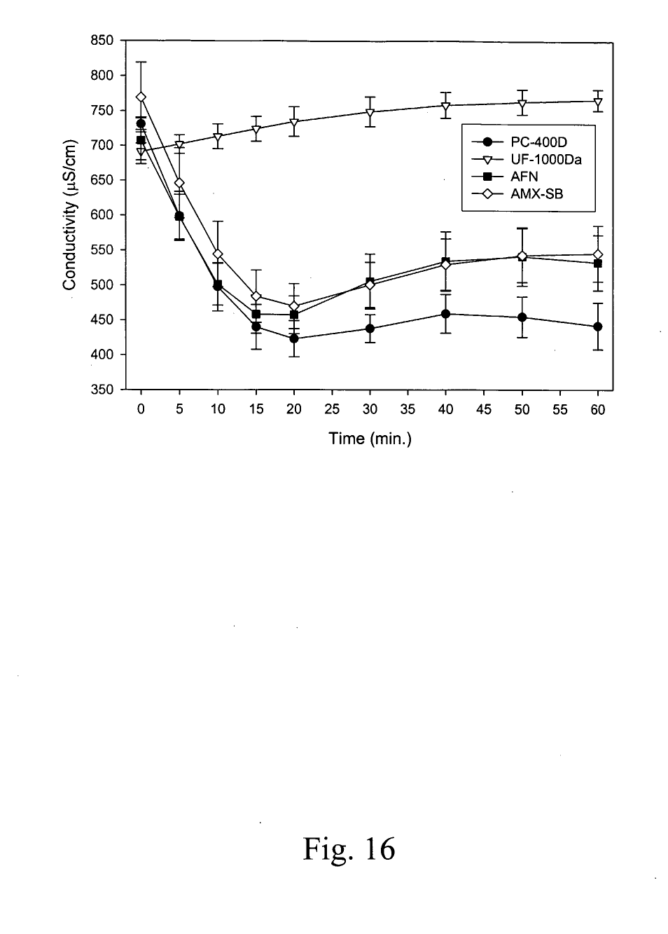

According to the ANOVA results, there was a significant effect of the membrane type (P<0.001) and duration (P<0.001) on conductivity evolution during ED treatment. There was also a significant dual-interaction between membranes type and duration (P<0.001) (FIG. 16).The LSD tests showed that ED treatments according to the type of membrane used were significantly different (P<0.001).

For the AFN and AMX-SB membranes, the evolution of the tea infusion conductivity was identical. It decreased rapidly from an averaged value of 742.00 PS/cm, at the beginning, to 463.50 μS/cm after 20 minutes of process. Then, tea conductivity slightly increased to 502.83 μS/cm after 30 minutes and remained constant at an averaged value of 536.20 μS/cm until the end of the ED process. The PC-400 Da membrane has a behaviour that is very similar to other anionic membranes but showed a lower average conductivity value for tea solution at the end of the process. Its conductivity decreased rapidly from an averaged value of 739.00 μS/cm, at the beginning of the electrodialysis, to 423.00 μS/cm after 20 minutes and then reached an average value of 448.25 μS/cm until the end of the treatment. At the opposite, the tea infusion conductivity increased in a linear fashion with the UF-1000 Da membrane, from 701.33 μS/cm at the beginning to 766.33 μS/cm after 60 minutes of electrodialysis process.

System Resistance

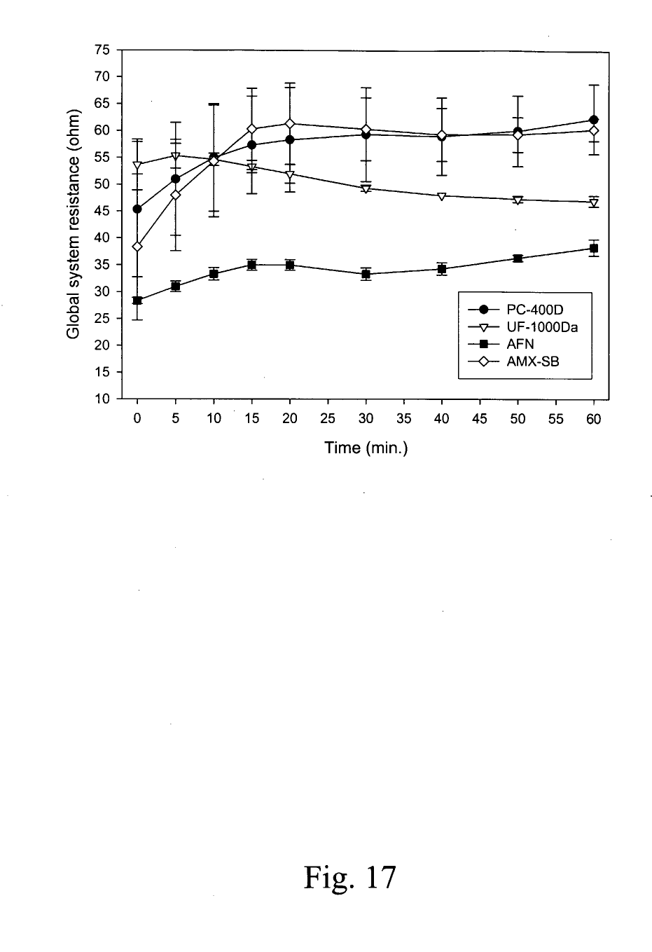

According to the ANOVA results, there is a significant effect of the treatments on the system resistance during the ED process (P<0.001). System resistance is influenced by the type of membrane used and the ED treatment duration because of the significant interaction between them (P<0.001) (FIG. 17). The LSD test show that there are significant differences between the ED treatments (P<0.001).

The evolution of the system resistance evolution was very similar for PC-400 Da and the AMX-SB. System resistance increased from an average value of 41.83Ω when current was applied at the very beginning of the ED process to a value of 58.83Ω after 15 minutes, to remain constant until the end of the treatment. The system resistance increased from 28.33Ω at the beginning, when current was applied, and then increased in a linear fashion to reach a value of 38.33Ω after 60 minutes of treatment with AFN membrane. The UF-1000 Da behaviour was different from the anionic membranes. System resistance increased from 0Ω at 0 minute to 53.67Ω when current was applied and decreased in a linear fashion until a value of 47.00Ω was reached at the end of the treatment.

A demineralization occurred during the electrodialysis process with the three cationic/anionic configurations. This demineralization increased the overall system resistance. However, the AFN system resistance is lower than the two other membranes. This is due to the lower electrical resistance of the AFN membrane, 0.4-1.5Ω·cm2 (Table 1). For the cationic/UF configuration, the migration of K+ cations to the tea compartment to keep the electro-neutrality of the solution during the process likely contributes to slow down the decrease of the system resistance.

Catechins and Caffeine

(−)-Epigallocatechin (EGC)

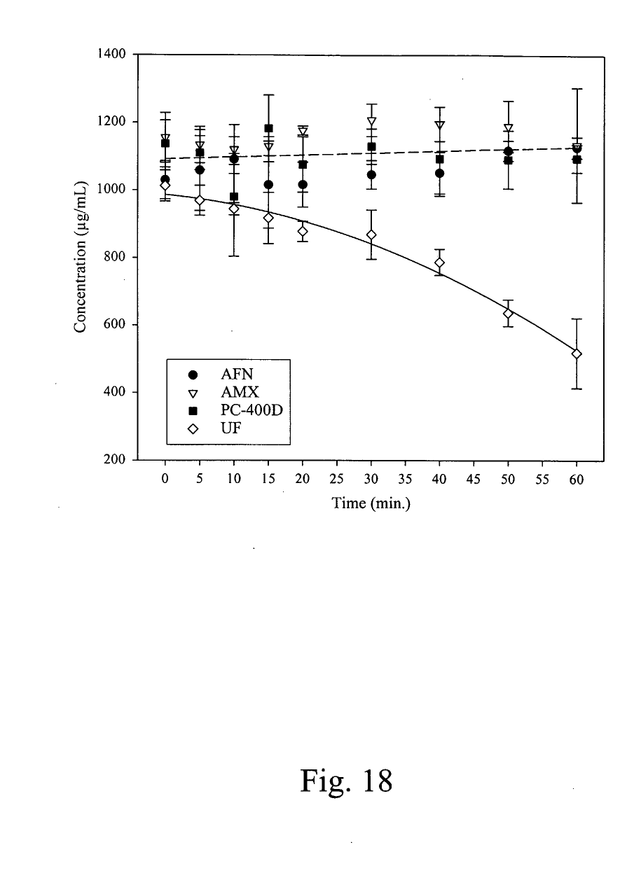

For the EGC, a membrane effect was observed (P<0.001) as a treatment duration effect (P<0.030) so a dual interaction of membrane and duration effect was observed (P<0.001). A second order equation was used to model the EGC migration behaviour (FIG. 18). There was a low concentration variation for the three anionic membranes, but the EGC concentration decreased by 50% with the UF-1000 Da membrane. Indeed, the EGC concentration decreased linearly from 1012.53 μg/ml at 0 min to 968.76 at 5 min, 943.95 μg/ml at 10 min, 878.06 μg/ml at 20 min, 787.31 μg/ml at 40 min and finally 518.27 μg/ml at 60 min. in the case of the UF-1000 Da membrane.

Caffeine (Caf)

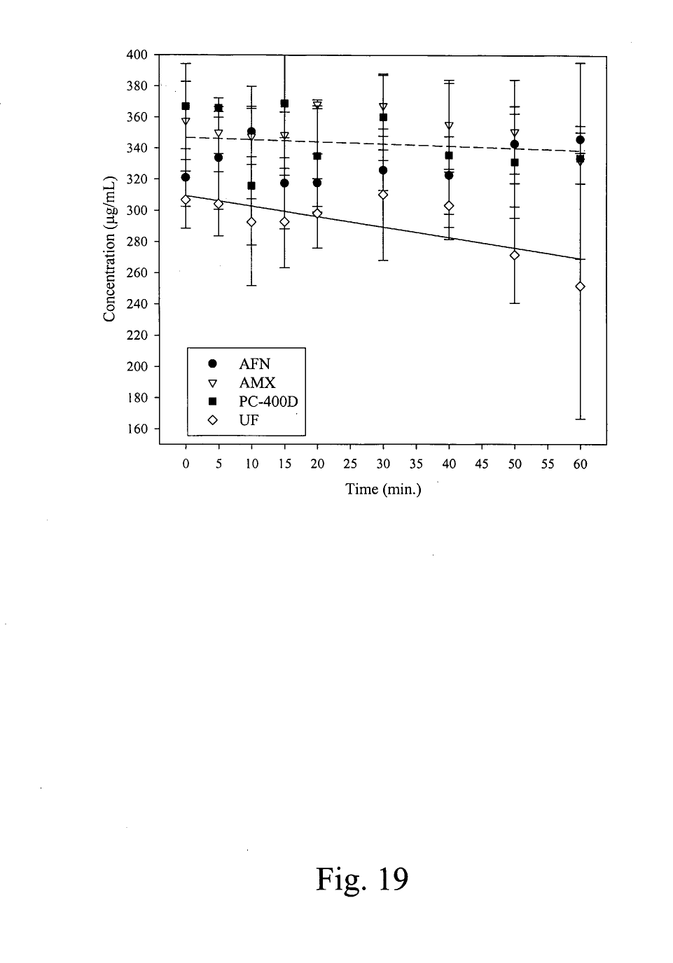

A membrane effect was observed on caffeine (P<0.001) migration, but no duration effect has been detected (P>0.722). A linear equation was used to model the caffeine migration behaviour (FIG. 19). Results show there was no significant variation of caffeine concentration during the electrodialysis process. An average value, during the entire treatment, of 331.00 μg/ml with the AFN membrane, 353.18 μg/ml with the AMX-SB membrane, 292.44 μg/ml with the UF-1000 Da membrane and 346.05 μg/ml with the PC-400 Da membrane was observed. Caffeine remains in the tea compartment.

(−)-Epicatechin (EC)

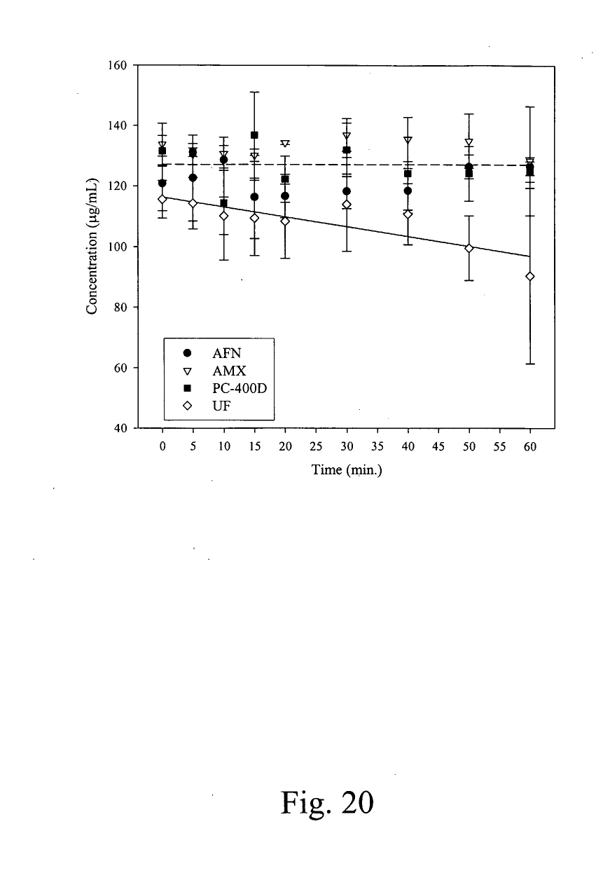

A membrane effect was observed on EC migration (P<0.001) but not with duration (P>0.723). A linear equation was used to model EC migration behaviour (FIG. 20). No EC concentration drop has been observed with the AFN, AMX-SB and PC-400 Da membranes. Apparently, EC concentration decreased with the UF-1000 Da membrane toward 40 minutes, but this is not statistically significant.

(−)-Epigallocatechin Gallate (EGCG)

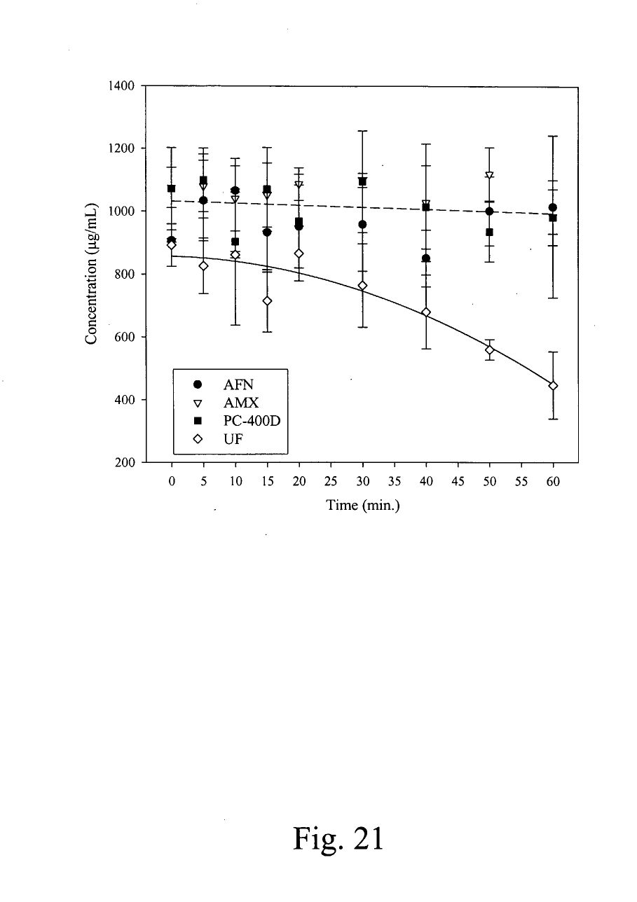

A membrane effect (P<0.001), a slight duration effect (P>0.066) and dual effect (P>0.079) were observed on the EGCG migration. A second order equation was used to model the EGC migration behaviour (FIG. 21). A very low EGCG concentration variation for the electrodialysis treatments was observed with AFN, AMX-SB and PC-400 Da membranes while a very high EGCG concentration variation, around 50%, was observed with the UF-1000 Da membrane. So EGCG concentration with the UF-1000 Da membrane decreased from 891.92 μg/ml at 0 min to 825.82 μg/ml after 5 min, 861.57 μg/ml at 10 min, 865.91 μg/ml at 20 min, 679.75 μg/ml at 40 min and finally 445.70 μg/ml after 60 min of treatment. A migration delay was noted with EGCG. Indeed, it seems that EGCG electrodialysis effectively began after 20 minutes of process, the EGCG concentration staying relatively constant in the 20 first minutes and after the beginning of its linear migration.

(−)-Gallocatechin Gallate (GCG)

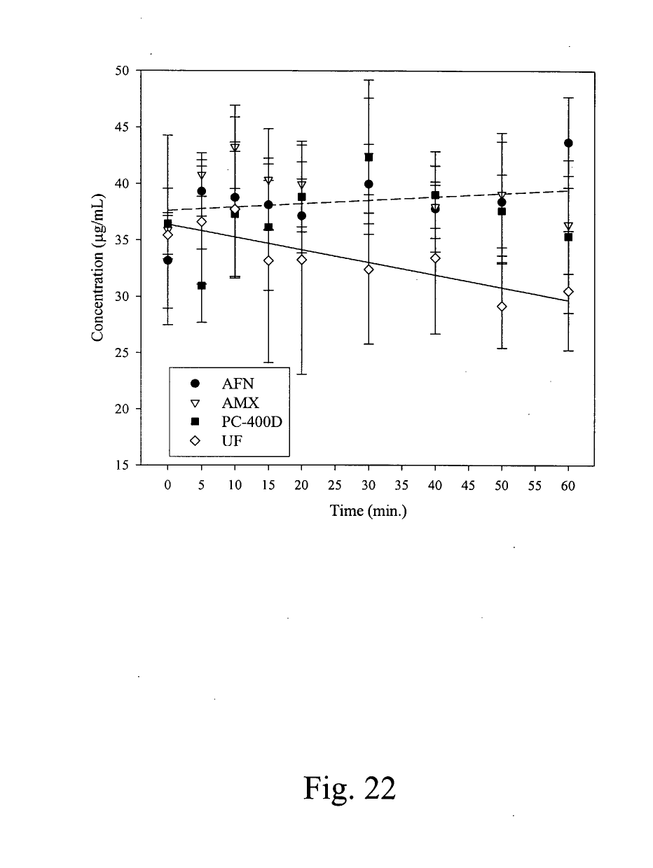

The GCG electrodialysis showed a membrane (P<0.001) effect but no duration effect (P>0.626) was observed. A linear equation was used to model the GCG migration behaviour (FIG. 22). According to the GCG low concentration, very few variation were observed, whatever the membrane type was used for the treatment. GCG variation during the treatment with the UF-1000 Da membrane was around 14%, but the appreciation of this decrease was difficult due to the high standard deviation values.

(−)-Epicatechin Gallate (ECG)

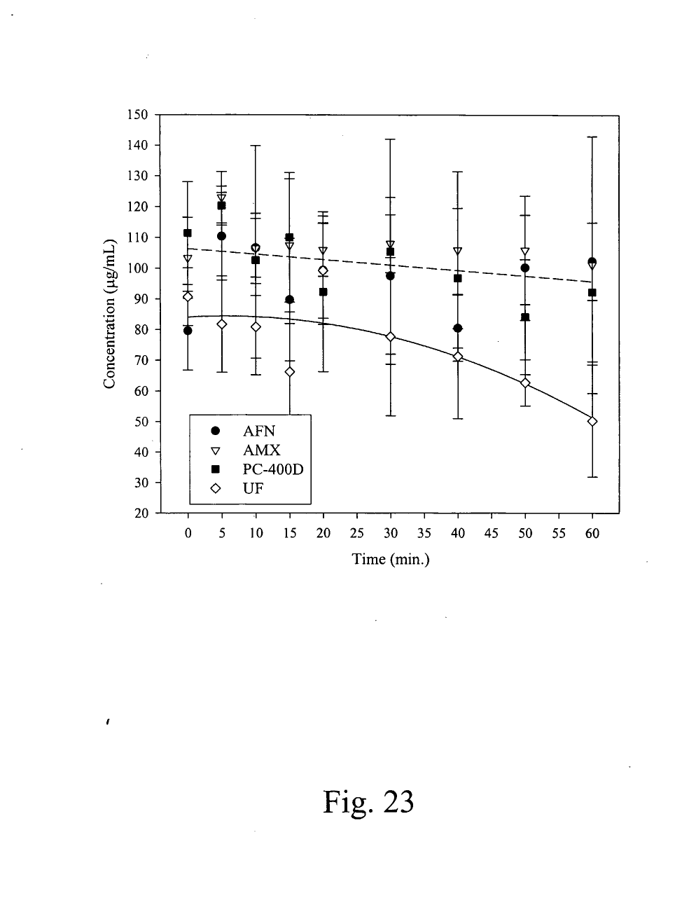

For the ECG, a membrane effect (P<0.001) was observed but there was no noticeable duration effect (P>0.209). A second order equation was used to model the ECG migration behaviour (FIG. 23). There was a very low ECG concentration variation during the treatment with the anionic membranes as with the UF-1000 Da membrane. The concentration variation between the treatment beginning and the end was not significant. Although there is no statistical significant difference for UF membrane, a slight decrease in ECG concentration after 30 minutes could be observed for a possible migration around 35%.

According to the results, the three anionic membranes do not show a statistical significant migration potential for the green tea catechins. AFN and AMX-SB membranes do not possess any pores that might allow the migration of organic molecules as big as catechins, which have a molecular weight ranging from 200 to 500 Da. No significant migration of catechins was observed with PC-400 Da membrane, even if it comprises pores that theoretically allow the passage of 400 Da molecules. This particular observation could be explain by the green tea acidification during the electrodialysis process that contribute to increase the catechins cationic charges and thus, to decrease the electrodialysis potential through such an anionic membrane. The decrease in pH during experiment explains the fact that no or low migration was observed since at pH 4.0, the electrical mobility of catechin was very low. This additionally shows the importance of the pH of the solutions in the maintenance of the charges of the compounds and molecules to be isolated and to keep the process efficient.

For the UF-1000 Da membrane, an EGC and EGCG migration of 50% was observed after 60 minutes of treatment. In the case of GCG, a non statistically significant migration of approximately 14% was observed. ECG concentration seems to be decreased from 35% after 30 minutes of treatment and EC seems to be decreased after 40 minutes. This decrease is however not statistically significant. No caffeine migration was observed with the UF membrane. The green tea basification during the treatment increased the catechins anionic charges and thus, increased the migration potential through the UF-1000 Da membrane. Moreover, the appropriate size of the UF-1000 Da membrane apertures enables the catechins to freely migrate through it. This is the first demonstration that an electrodialysis method can be used as a method for purifying catechins.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A process for separation or concentration of organic of at least one of neutral or charged compounds in a feed solution, said process comprising the steps of:
a) passing at least once a feed solution containing neutral and charged organic compounds through an electrodialysis cell under electrical field, said electrodialysis cell comprising at least one charged membrane, and at least one filtration membrane, said cell being operated with no pressure differential between the cell compartments; and
b) collecting separated fractions of permeate after passage of said neutral or charged compounds through said filtration membrane, each separated fraction containing separately neutral or charged compounds,
wherein an ionic solution circulates between said charged membrane and said filtration membrane on the side of the filtration membrane opposed to the side on which circulates the charged compounds containing feed solution, the charged compounds passing through said filtration membrane in the ionic solution during passage in the electrodialysis cell, and neutral compounds remaining in the feed solution.

2. The process of claim 1, wherein said electrodialysis cell comprises, at least one cationic membrane, at least one filtration membrane, and at least one anionic membrane on the side of the filtration membrane opposed to the side of the cationic membrane.

3. The process of claim 1, wherein pH of said feed solution is adjusted to preserve the charges of said compounds.

4. The process of claim 1 being a batch recirculation process.

5. The process of claim 1, wherein said neutral or charged organic compounds are separated simultaneously during performing the process.

6. The process of claim 1, wherein said filtration membrane is a cellulose ester ultrafiltration membrane.

7. The process of claim 1, wherein said filtration membrane has a molecular weight cut off selected in the range of between 0.1 to 50 000 kDa.

8. The process of claim 1, wherein said filtration membrane is charged or neutral membrane.

9. The process of claim 1, wherein pH of said feed solution is of between 2 to 11.5.

10. The process of claim 1, wherein said compounds are of animal or vegetable origin.

11. The process of claim 1, wherein said compounds are physically, chemically or enzymatically hydrolyzed before performing step a).

12. The process of claim 1, wherein said composition flows through said electrodialysis cell at a rate of between 0.1 to 10 L/min., and said permeated at a rate of 0.1 to 150 L/min.

13. The process of claim 1, wherein said feed solution of step a) comprises neutral organic compounds.

14. The process of claim 1, wherein said passing of step a) is performed by continuous recirculation of the feed solution through the electrodialysis cell.

15. The process of claim 1, wherein said permeate is an aqueous solution or a salted solution thereof.

16. The process of claim 12, wherein said permeate comprises salts at a concentration between 0.01 to 10 g/L.

17. The process of claim 1, wherein said feed solution comprises acid compounds having pH of below 5.0, neutral compounds having pH between 5.0 to 8.0, and basic compounds having pH over 8.0.

18. The process of claim 1, wherein where at least two filtration membranes are used to allow targeted molecular weight separation of said compounds in combination with charge separation.

19. The process of claim 1, wherein said electrodialysis cell comprises at least two filtration membranes, each filtration membrane having molecular weight cut-off different from the other or the others.

20. The process of claim 1, wherein said electrodialysis cell comprises at least one cationic membrane, at least one filtration membrane and at least one anionic membrane, each membrane being separately compartmented.

21. The process of claim 18, wherein pH in a compartment is different from pH of others compartments.

22. The process of claim 1, wherein said electrical field is pulsed.

23. The process of claim 1, wherein said electrical field comprises pulse periods of inverted electrical field.

24. A system for separation or concentration of organic charged compounds and neutral compounds in a feed solution, said system comprising an electrodialysis cell having spaced-apart positive and negative electrodes, at least one charged membrane, and at least one filtration membrane, the electrodialysis cell having a first compartment defined between the at least one charged membrane and the at least one filtration membrane for receiving a flow of ionic solution, and a second compartment provided on a side of the at least one filtration membrane opposite to said at least one charged membrane for receiving a flow of feed solution, the charged compounds contained in the feed solution passing under electric forces with no pressure through said at least one filtration membrane into the ionic solution, the neutral compounds contained in the feed solution remaining in the feed solution.

25. The system of claim 24, wherein said electrodialysis cell further comprises, at least one cationic membrane, and at least one anionic membrane, said anionic membrane being provided on the side of the filtration membrane opposed to the side of the cationic membrane.
